(19) United States
(12) Patent Application Publication
(10) Pub. No.: US 2009/0106807 A1
(43) Pub. Date: Apr. 23, 2009

(54) Video Distribution System for Switching Video Streams

(75) Inventors: Toshiaki SUZUKI, Hachioji (JP); Mariko Nakayama, Tokyo (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi, Ltd.

(21) Appl. No.: 12/253,272

(22) Filed: Oct. 17, 2008

(30) Foreign Application Priority Data
Oct. 19, 2007 (JP) 2007-272348
Jan. 17, 2008 (JP) 2008-7921

(51) Int. Cl. H04N 7/173; H04N 7/12

(52) U.S. Cl. 725/114; 725/134; 375/240.01; 375/E07.076

(57) ABSTRACT

Provided is a video distribution system including: a video server for transmitting a plurality of video streams; and a video gateway for transferring at least one of the plurality of the transmitted video streams to a video client. The video server adds a first identifier for identifying whether data of an independently decodable unit included in the video stream corresponds in time to the video stream; and transmits the video stream to which the first identifier has been added. The video gateway specifies, based on first identifiers added to the transmitted plurality of video streams, the data of the independently decodable unit of the video stream transferred after switching in a case where the video stream is switched to another video stream in the independently decodable unit; and transfers the video stream transferred after the switching from the specified data of the independently decodable unit.

### CLAIM OF PRIORITY

The present application claims priority from Japanese patent applications JP 2007-272348 filed on Oct. 19, 2007, and JP 2008-007921 filed on Jan. 17, 2008, the contents of which are hereby incorporated by reference into this application.

### BACKGROUND OF THE INVENTION

This invention relates to a video distribution system for distributing video streams, and more particularly, to a method of switching a plurality of video streams.

Popularity of a network technology has brought about a development of a technology for transmitting video streams by using Internet Protocol (IP). Such a video stream transmission technology includes a method for distributing video streams in real time by using IP multicasting, and a method for downloading a video stream to play stored data. As a method for encoding video data, a method that uses Moving Picture Experts Group 2 (MPEG 2) is known. As a method for distributing video streams, a study has been made on a method for distributing video streams in real time through IP multicasting which uses a real-time transport protocol/user datagram protocol (RTP/UDP).

With achievement of a broadband of a communication line, a video distribution system has been proposed, which distributes videos from a plurality of viewpoints and enables a user to select a video as wished (e.g., JP 2003-179908 A). The video server disclosed in JP 2003-179908 A generates additional information indicating a content of a video for each video frame, and distributes a video stream based on the generated additional information.

A video display device has been known, which automatically selects a video stream among video streams captured from a plurality of viewpoints according to user's preference (e.g., JP 2004-312208 A). The video display device disclosed in JP 2004-312208 A automatically selects a video stream according to user's preference, by using meta-data containing an identifier of a subject of a video stream for each video frame.

In the case of switching a video channel, a system for switching at an I frame of a switching destination video channel is known (e.g., JP 2001-516184 A). A channel changer disclosed in JP 2001-516184 A switches a video channel at an I frame stored in a switching destination buffer to distribute a video stream.

In a video encoding method which predicts a frame based on similarities between frames as in the case of the MPEG 2, there are known frames called an I frame, a P frame, and a B frame. The I frame is a frame generated without using any inter-frame prediction, and can be played alone. The P frame is a frame played by prediction in a forward direction (forward prediction) from other I and P frames. Specifically, the P frame is a frame compressed and encoded by using an I or P frame that precedes in time. Thus, to decode the P frame, an I or P frame that has been used in compression and encoding is necessary.

The B frame is a frame compressed and encoded by using data of I and P frames that precede and succeed in time. Thus, to decode the B frame, an I or P frame that has been used in compression and encoding is necessary.

### SUMMARY OF THE INVENTION

In the case of switching videos of a plurality of viewpoints to transmit them to a video client, in the video encoding method which uses inter-frame prediction as in the case of the MPEG 2, information of previous and subsequent frames is used for playing the videos. Thus, when the video stream is not switched at an appropriate point, the terminal that has received the switched stream cannot correctly play the video. In the MPEG 2, a plurality of frames are managed as a group, and this group is called a group of pictures (GOP). The GOP is a video playing unit which contains at least one I frame, a plurality of P frames, and a plurality of B frames.

In the case of editing a video without re-encoding, the editing has to be carried out in a video playing unit. Thus, when decoding is executed not from video data of the I frame but from video data from the P or B frame, a video to be played is disturbed.

To switch a video so that the video client can correctly play a stream, a video stream has to be switched by taking a playing unit of the video stream into consideration.

However, in the case of the conventional technologies (JP 2003-179908 A and JP 2004-312208 A), because of switching of the video in a video frame unit, there is a first problem of impossibility of switching the video in a playing unit of the video stream.

In the case of distributing videos from a plurality of video servers by using an IP network, video streams are not distributed in synchronization. Thus, a start point of a new stream started to be transferred (start stream) does not always arrive immediately after an end point of a stream finished to be transferred (end stream). In the IP network, an arrival order of IP packets is not guaranteed. Thus, a notification of stream switching point may arrive at a video gateway after a stream packet to be switched. When the stream is switched to another at the time of notification arrival, the start stream cannot be transmitted from the start point, nor can transmission of the end stream be finished at the end point.

The channel changer disclosed in JP 2001-516184 A distributes, after reception of a channel switching instruction, the video streams from the switching destination I frame regardless of a position of a played frame before channel switching. Thus, when the channel is switched in the middle of the video frame before switching, only a part of data constituting the video frame is transmitted, causing a second problem of disturbance of a video to be played.

FIG. 20 illustrates a relation between a transmission order of video frames being transmitted and a playing order of video frames being played. As illustrated in FIG. 20, for data of the I or P frame, a video frame is played after a video of a subsequent B frame is decoded. Thus, for example, when the video frame is switched to another immediately before a B(3) frame as indicated by 450 of FIG. 20, on the playing side, a P(5) frame is played despite omission of B(3) and B(4) frames. Consequently, a third problem of discontinuity of videos to be played is generated.

As timing of switching videos, for example, when a video stream is switched to another immediately before a P(11) frame indicated by 451 of FIG. 20, on the playing side, B(6), B(7) and P(8) frames are played, thus causing no discontinuity of videos to be played. However, 6 out of 15 frames B(0) to P(14) as GOP units are omitted. Thus, a fourth problem of a reduction in data amount of all the videos to be played is generated.

In switching a video stream to another, in order to switch video data without omitting any video frame, a method for switching video data in GOP units before and after switching of the video data may be used. However, in the IP network, video frames are not transmitted in synchronization. Thus, a fifth problem of impossibility of switching GOP units synchronized between the video streams is generated.

This invention has been developed to solve the aforementioned problems, and is directed to distribution, when a user-desired video selected by switching among a plurality of stream-distributed videos is distributed to a video client, of video streams whose videos can be continuously played without any interference of video playing at the video client from a video gateway.

The invention is directed to a video stream distribution system which distributes video streams through switching in GOP units.

A representative aspect of this invention is as follows. That is, there is provided a video distribution system including: a video server for transmitting a video stream; and a video gateway for receiving a plurality of the transmitted video streams, and transferring at least one of the received plurality of the transmitted video streams to a video client. The video server adds a first identifier for identifying whether data of an independently decodable unit included in the video stream corresponds in time to the video stream; and transmits the video stream to which the first identifier has been added. The video gateway specifies, based on first identifiers added to the received plurality of video streams, the data of the independently decodable unit of the video stream transferred after the switching in a case where the video stream is switched to another video stream in the independently decodable unit; and transfers the video stream transferred after the switching from the specified data of the independently decodable unit.

According to the exemplary embodiment of this invention, by taking playing units of video streams into consideration, videos can be switched to be playable without any boundaries.

### BRIEF DESCRIPTION OF THE DRAWINGS

The present invention can be appreciated by the description which follows in conjunction with the following figures, wherein:

FIG. 1 is a configuration diagram illustrating a configuration of a video distribution system according to a first embodiment of this invention;

FIG. 2 is a sequence diagram illustrating a video stream data transmission/reception processing of the video distribution system according to the first embodiment of this invention;

FIG. 3 is a block diagram illustrating a configuration of a meta-data server according to the first embodiment of this invention;

FIG. 4 is a flowchart illustrating a meta-data distribution processing according to the first embodiment of this invention;

FIG. 5 is an explanatory diagram illustrating a configuration of a transmission packet of meta-data to be distributed from the meta-data server to a video gateway according to the first embodiment of this invention;

FIG. 6 is a block diagram illustrating a configuration of the video server according to the first embodiment of this invention.

FIG. 7 is a flowchart illustrating a video distribution processing according to the first embodiment of this invention.

FIG. 8 is an explanatory diagram illustrating a configuration of an RTP header according to the first embodiment of this invention.

FIG. 9 is an explanatory diagram illustrating a relation between P and M bits and heads of GOP and video frame data in an RTP header according to the first embodiment of this invention.

FIG. 10 is an explanatory diagram illustrating a configuration of an extended header of an RTP packet according to the first embodiment of this invention.

FIG. 11 is an explanatory diagram illustrating a configuration of a packet where MPEG-2 TS packets are converted into RTP, UDP, and IP packets according to the first embodiment of this invention.

FIG. 12 is a block diagram illustrating a configuration of the video gateway according to the first embodiment of this invention.

FIGS. 13A and 13B are flowcharts illustrating a video relaying processing according to the first embodiment of this invention.

FIG. 14 is a block diagram illustrating a configuration of the video client according to the first embodiment of this invention.

FIG. 15 is a flowchart illustrating a video reception processing according to the first embodiment of this invention.

FIG. 16 is an explanatory diagram illustrating a display screen displayed in a display unit of the video client according to the first embodiment of this invention.

FIG. 17 is a configuration diagram illustrating a configuration of a video distribution system according to a second embodiment of this invention.

FIG. 18 is a sequence diagram illustrating a sequence of video stream data transmission/reception processing in the video distribution system according to the second embodiment of this invention.

FIG. 19 is a flowchart illustrating video relaying processing according to the second embodiment of this invention.

FIG. 20 is an explanatory diagram illustrating a relation between a transmission order of video frames being transmitted and a playing order of video frames being played.

FIG. 21 is an explanatory diagram illustrating a playing order of GOP video data according to the first embodiment of this invention.

FIG. 22 is an explanatory diagram illustrating a display screen displayed in a display unit of a video client according to the second embodiment of this invention.

FIG. 23 is a configuration diagram illustrating a configuration of a video distribution system according to a third embodiment of this invention.

FIG. 24 is a flowchart illustrating video reception processing according to the third embodiment of this invention.

FIG. 25 is a configuration diagram illustrating a configuration of a video distribution system according to a fourth embodiment of this invention.

FIG. 26 is a configuration diagram illustrating a configuration of a video distribution system according to a fifth embodiment of this invention.

FIG. 27 is a block diagram illustrating a configuration of a video server according to a sixth embodiment of this invention.

FIG. 28 is a flowchart illustrating video distribution processing according to the sixth embodiment of this invention.

FIG. 29 is a sequence diagram illustrating a sequence of video stream data transmission/reception process of a video distribution system according to the seventh embodiment of this invention.

FIG. 30 is a flowchart illustrating video relaying processing according to the seventh embodiment of this invention.

FIG. 31 is a flowchart illustrating video reception processing according to the seventh embodiment of this invention.

FIG. 32 is a configuration diagram illustrating a configuration of a video distribution system according to an eighth embodiment of this invention.

FIG. 33 is a configuration diagram illustrating a configuration of a video distribution system according to a ninth embodiment of this invention.

FIG. 34 is a block diagram illustrating a configuration of a video gateway according to the ninth embodiment of this invention.

FIG. 35 is an explanatory diagram illustrating a configuration of a memory of the video gateway according to the ninth embodiment.

FIG. 36 is an explanatory diagram illustrating a configuration example of a terminal management table according to the ninth embodiment of this invention.

FIG. 37 is an explanatory diagram illustrating a configuration example of a stream management table according to the ninth embodiment of this invention.

FIG. 38 is an explanatory diagram illustrating a configuration of a memory of each of video servers A to C according to the ninth embodiment of this invention.

FIG. 39 is a flowchart illustrating stream packet generation processing according to the ninth embodiment of this invention.

FIG. 40 is an explanatory diagram illustrating a configuration of an RTP header according to the ninth embodiment of this invention.

FIG. 41 is an explanatory diagram illustrating a configuration example of an IP packet generated and output to the line according to the ninth embodiment of this invention.

FIG. 42 is an explanatory diagram illustrating a configuration of a memory of a metadata server according to the ninth embodiment of this invention.

FIG. 43 is an explanatory diagram illustrating a configuration example of a metadata notification according to the ninth embodiment of this invention.

FIG. 44 is an explanatory diagram illustrating a configuration of a memory of a video client according to the ninth embodiment of this invention.

FIG. 45 is a sequence diagram illustrating video stream switching processing according to the ninth embodiment of this invention.

FIG. 46 is a flowchart illustrating personalized stream control processing according to the ninth embodiment of this invention.

FIG. 47 is a flowchart illustrating personalized stream distribution processing according to the ninth embodiment of this invention.

FIG. 48 is an explanatory diagram illustrating a configuration of a buffer which stores an RTP packet according to the ninth embodiment of this invention.

FIG. 49 is a flowchart illustrating metadata analysis processing according to the ninth embodiment of this invention.

FIG. 50 is an explanatory diagram illustrating a personalized stream according to the ninth embodiment of this invention.

FIG. 51 is a flowchart illustrating stream packet generation processing according to a tenth embodiment of this invention.

FIG. 52 is an explanatory diagram illustrating a configuration of an extended header of an RTP according to the tenth embodiment of this invention.

FIG. 53 is a flowchart illustrating personalized stream distribution processing according to the tenth embodiment of this invention.

FIG. 54 is a sequence diagram illustrating video stream switching processing according to the tenth embodiment of this invention.

FIG. 55 is an explanatory diagram illustrating a personalized stream according to the tenth embodiment of this invention.

FIG. 56 is a configuration diagram illustrating a system configuration of a video distribution system according to an eleventh embodiment of this invention.

FIG. 57 is a sequence diagram illustrating video stream switching processing according to the eleventh embodiment of this invention.

FIG. 58 is a sequence diagram illustrating video stream switching processing according to a twelfth embodiment of this invention.

### DETAILED DESCRIPTION OF THE PREFERRED EMBODIMENTS

### First Embodiment

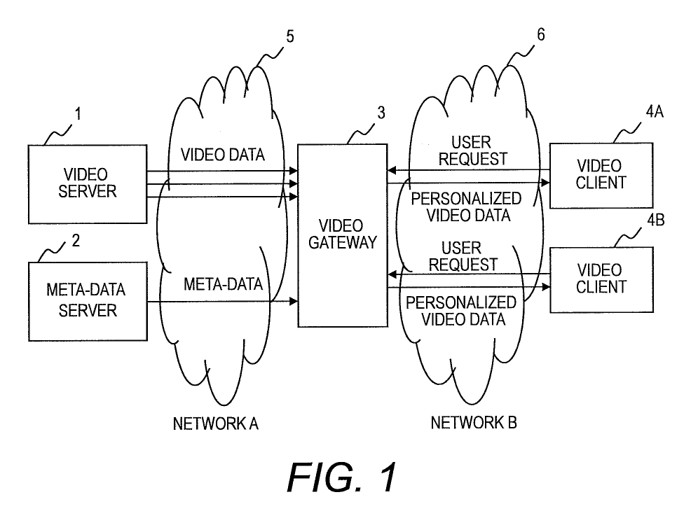

FIG. 1 illustrates a configuration of a video distribution system according to a first embodiment of this invention.

The video distribution system of the first embodiment includes a video server 1, a meta-data server 2, a video gateway 3, video clients 4A and 4B, and networks A and B (5 and 6). Hereinafter, the video clients 4A and 4B may be collectively referred to as a video client 4.

The network A 5 interconnects the video server 1, the meta-data server 2, and the video gateway 3. The network B 6 interconnects the video gateway 3 and the video clients 4A and 4B.

The video server 1 distributes multi-viewpoint video stream (video data) to the video gateway 3. The meta-data server 2 distributes meta-data indicating contents of the video streams distributed from the video server 1 to the video gateway 3.

The video gateway 3 outputs data of a personalized video stream of the multi-viewpoint video stream based on the multi-viewpoint video stream received from the video server 1, the meta-data received from the meta-data server 2, and user requests received from the video clients 4A and 4B. The output data of the video stream is distributed to the video clients 4A and 4B. The output data of the video stream may be played by, for example, a display device connected to the video gateway 3.

The video clients 4A and 4B transmit the user requests to the video gateway 3, and play the data of the video stream received from the video gateway 3.

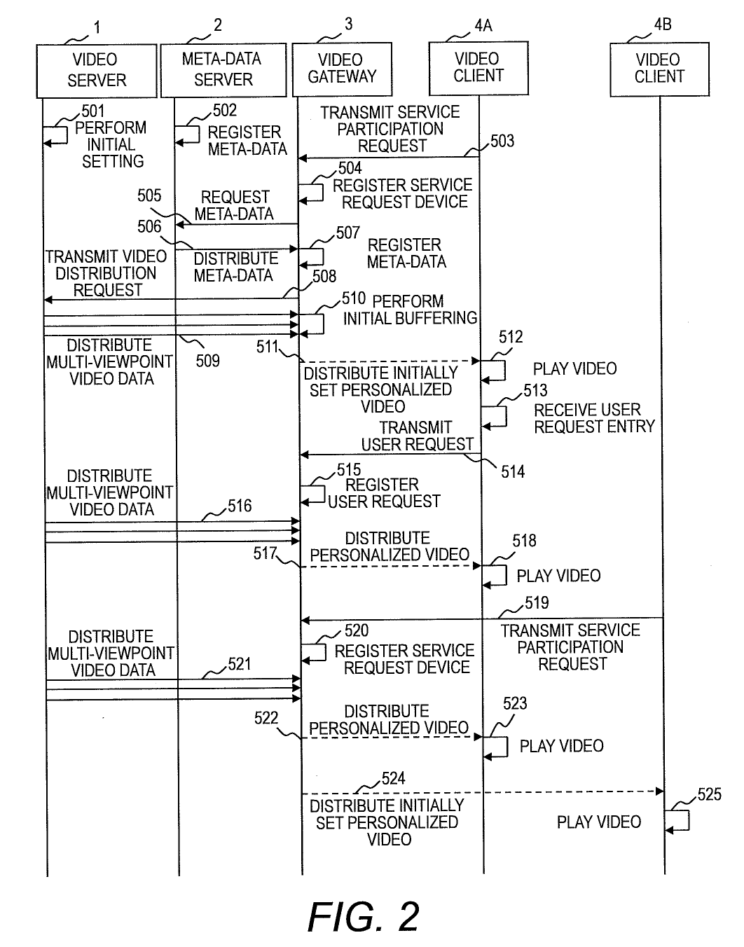

FIG. 2 is a sequence diagram illustrating a video stream data transmission/reception processing of the video distribution system according to the first embodiment of this invention.

When started, the video server 1 performs 0-value initial setting of a GOP number to distribute video data (Step 501). The 0-value initial setting of the GOP number means initialization of the GOP number added when a video stream of each viewpoint is packetized to 0.

When started, the meta-data server 2 registers meta-data information to be distributed to the video gateway 3 by an administrator (Step 502).

Then, when started, the video client 4A transmits participation request data in a video distribution service to the video gateway 3 (Step 503).

The video gateway 3 receives the participation request data in the video distribution service transmitted from the video client 4A, and registers an identifier (e.g., IP address of the video client 4A) of the video client 4A which has requested the participation in the video distribution service (Step 504).

The video gateway 3 requests, because of presence of the video client 4 wishing to participate in the video distribution service, meta-data of video data to be distributed to the meta-data server 2 (Step 505).

The meta-data server 2 that has received the meta-data request from the video gateway 3 distributes the meta-data information registered in Step 502 to the video gateway 3 (Step 506).

The video gateway 3 registers the meta-data information received from the meta-data server 2 (Step 507). The video gateway 3 transmits a request of multi-viewpoint video data distribution to be serviced to the video server 1 (Step 508).

The video server 1 receives the video data distribution request from the video gateway 3, and distributes multi-viewpoint video data to the video gateway 3 by using a multicasting method (Step 509).

The video gateway 3 starts reception of the multi-viewpoint video data distributed from the video server 1, and buffers the received video data until reception of maximum delay video data of 1 GOP (Step 510). Then, according to initial setting (e.g., setting that video data of a viewpoint received at a minimum delay is initially distributed data), the video gateway 3 distributes personalized video data to the video client 4A (Step 511).

The video client 4A plays the received personalized video data (Step 512).

Then, the video client 4A receives request data (e.g., “player A”) entered by the user (Step 513). The video client 4A transmits the entered user request data to the video gateway 3 (Step 514).

The video gateway 3 receives the user request data transmitted from the video client 4A to register it (Step 515).

The video server 1 continues distribution of the multi-viewpoint video data (Step 516).

The video gateway 3 specifies, in the meta-data registered in Step 507, a video of a viewpoint which matches the user request data received in Step 515 to switch the viewpoint in a GOP unit. Then, the video gateway 3 distributes the video data of the switched viewpoint as personalized video data to the video client 4A (Step 517).

Then, the video client 4A receives the personalized video data distributed from the video gateway 3 to play the received personalized video data (Step 518).

When started, the video client 4B transmits participation request data in a video distribution service to the video gateway 3 (Step 519).

The video gateway 3 receives the participation request data in the video distribution service transmitted from the video client 4B, and registers an identifier (e.g., IP address) of the video client 4B which has requested the participation in the video distribution service (Step 520).

The video server 1 continues distribution of the multi-viewpoint video data (Step 521).

The video gateway 3 distributes the video data of the viewpoint specified in Step 517 as personalized video data to the video client 4A (Step 522).

Then, the video client 4A receives the personalized video data distributed from the video gateway 3 to play the received personalized video data (Step 523).

Then, according to initial setting (e.g., setting that video data of a viewpoint received at a minimum delay is initially distributed data), the video gateway 3 distributes the personalized video data to the video client 4B (Step 524).

Then, the video client 4B receives the personalized video data distributed from the video gateway 3 to play the received personalized video data (Step 525).

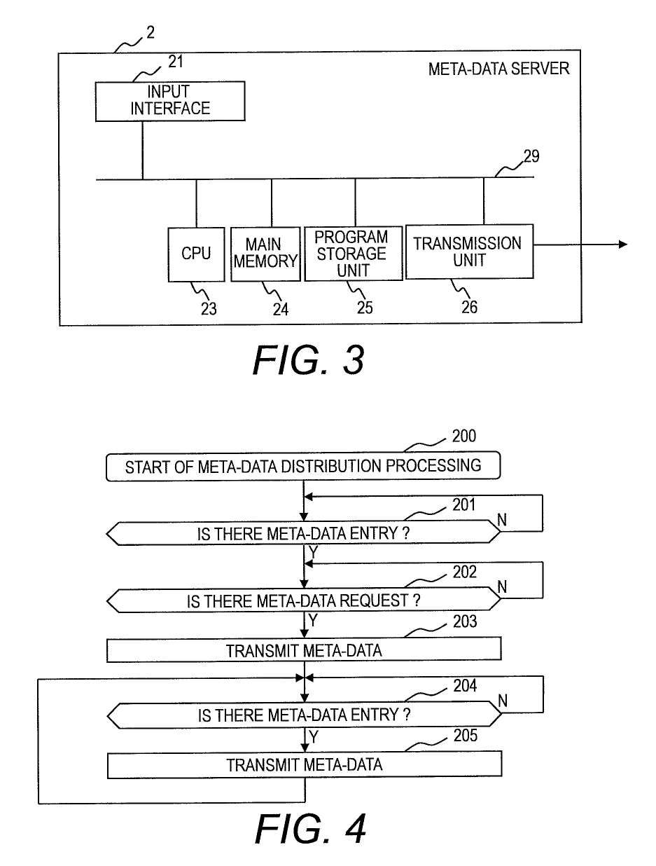

FIG. 3 is a block diagram illustrating a configuration of the meta-data server 2 according to the first embodiment of this invention.

The meta-data server 2 includes an input interface 21, a CPU 23, a main memory 24, a program storage unit 25, and a transmission unit 26. The input interface 21, the CPU 23, the main memory 24, the program storage unit 25, and the transmission unit 26 are interconnected via a bus 29.

The input interface 21 is an interface used by a service administrator to enter meta-data indicating a content of a video to be distributed. The input interface 21 may include, for example, a keyboard.

The CPU 23 executes an operating system (OS) and various application programs. The main memory 24 temporarily stores data necessary when the CPU 23 executes various application programs. In the main memory 24, at least a part of a program stored in the program storage unit 25 is copied when necessary. The program storage unit 25 stores various application programs. The transmission unit 26 is an interface for distributing the meta-data entered by the administrator via the network A 5.

An operation of the meta-data server 2 will be described.

FIG. 4 is a flowchart illustrating a meta-data distribution processing according to the first embodiment of this invention.

The meta-data server 2 reads the program stored in the program storage unit 25 to the CPU 23, and the CPU 23 executes the read program to start the meta-data distribution processing (Step 200).

First, the meta-data server 2 judges whether the administrator has entered meta-data (Step 201).

If it is judged in Step 201 that the administrator has entered the meta-data, the process proceeds to Step 202. On the other hand, if it is judged in Step 201 that the administrator has entered no meta-data, Step 201 is repeated to judge whether any meta-data has been entered from the administrator.

The meta-data server 2 judges whether a meta-data request has been received from the video gateway 3 (Step 202).

If it is judged in Step 202 that a meta-data request has been received from the video gateway 3, the process proceeds to Step 203. On the other hand, if it is judged in Step 202 that no meta-data request has been received from the video gateway 3, Step 202 is repeated to judge whether any meta-data request has been received from the video gateway 3.

The meta-data server 2 distributes meta-data information entered from the administrator to the video gateway 3 (Step 203).

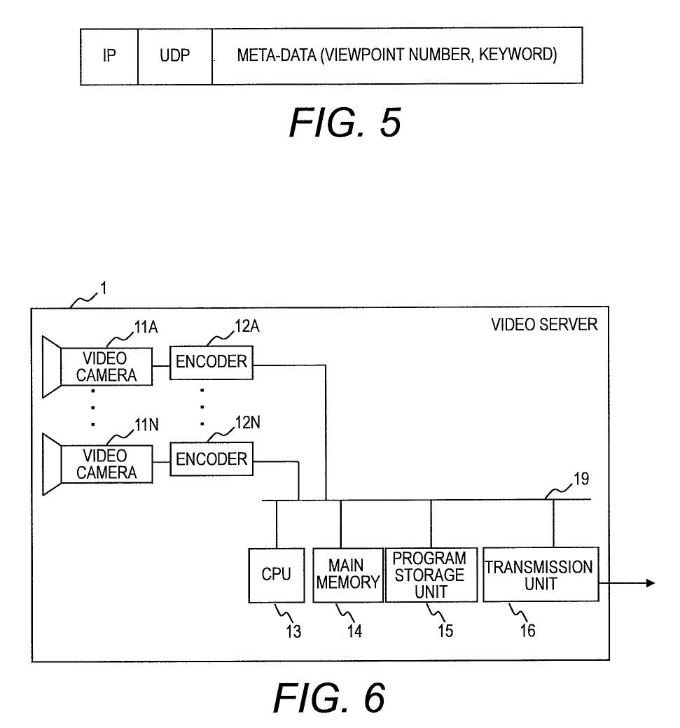

FIG. 5 illustrates a configuration of a transmission packet of meta-data to be distributed from the meta-data server 2 to the video gateway 3. Meta-data of a distribution target is converted into a UDP packet or an IP packet to be distributed from the meta-data server 2 to the video gateway 3. The meta-data may contain, for example, information of “viewpoint 1: player A”.

Next, the meta-data server 2 judges whether the administrator has entered meta-data (Step 204).

If it is judged in Step 204 that the administrator has entered the meta-data, the process proceeds to Step 205. On the other hand, if it is judged in Step 204 that the administrator has entered no meta-data, Step 204 is repeated to judge whether any meta-data has been entered from the administrator.

Then, the meta-data server 2 distributes the meta-data information entered from the administrator to the video gateway 3 (Step 205). The process returns to Step 204 to judge whether the administrator has entered meta-data to be distributed.

FIG. 6 is a block diagram illustrating a configuration of the video server 1 according to the first embodiment of this invention.

The video server 1 includes video cameras 11A to 11N, encoders 12A to 12N, a CPU 13, a main memory 14, a program storage unit 15, and a transmission unit 16. The video cameras 11A to 11N, the encoders 12A to 12N, the CPU 13, the main memory 14, the program storage unit 15, and the transmission unit 16 are interconnected via a bus 19. Hereinafter, the video cameras 11A to 11N may be collectively referred to as a video camera 11. The encoders 12A to 12N may be collectively referred to as an encoder 12.

The video camera 11 captures videos of a plurality of viewpoints. The encoder 12 encodes (e.g., compression and encoding based on MPEG 2) video data of each viewpoint captured by the video camera 11. The CPU 13 executes an operating system (OS) and various application programs. The main memory 14 temporarily stores data necessary when the CPU 13 executes various application programs. In the main memory 14, at least a part of a program stored in the program storage unit 15 is copied when necessary. The program storage unit 15 stores various application programs. The transmission unit 16 is an interface for distributing the encoded video data via the network A 5.

Next, an operation of the video server 1 will be described.

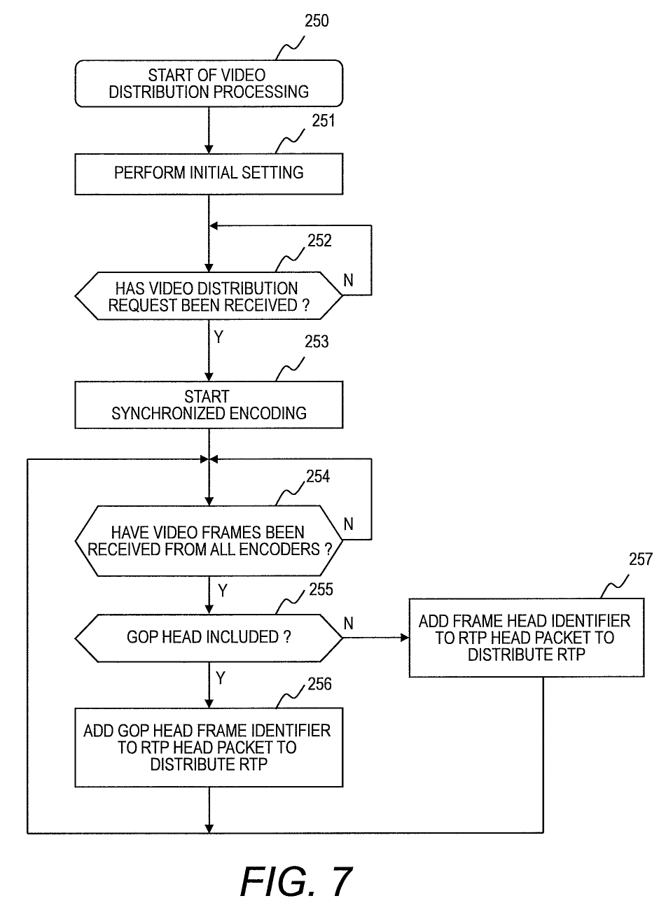

FIG. 7 is a flowchart illustrating a video distribution processing according to the first embodiment of this invention.

The video server 1 reads the program stored in the program storage unit 15 to the CPU 13, and the CPU 13 executes the read program to start the video distribution processing (Step 250).

First, the video server 1 performs 0-value initial setting of a GOP number to distribute video data (Step 251).

The video server 1 judges whether a video distribution request has been received from the video gateway 3 (Step 252).

If it is judged in Step 252 that a video distribution request has been received from the video gateway 3, the process proceeds to Step 253. On the other hand, if it is judged in Step 252 that no video distribution request has been received from the video gateway 3, Step 252 is repeated to judge whether any video distribution request has been received from the video gateway 3.

The video server 1 encodes video data of a plurality of viewpoints in synchronization (Step 253). Specifically, the video server 1 matches GOP numbers added to the video data of the viewpoints to compress and encode the video data.

The video server 1 judges whether video frame data have been received from all the encoders 12 (Step 254).

If it is judged in Step 254 that video frame data have been received from all the encoders 12, the process proceeds to Step 255. On the other hand, if it is judged in Step 254 that video frame data has not been received from all the encoders 12, Step 254 is repeated to judge whether video frame data have been received from all the encoders 12.

Then, the video server 1 judges whether the received video data contains head data of GOP (head frame data of GOP) (Step 255).

If it is judged in Step 255 that the received video data contains head data of the GOP, the process proceeds to Step 256. On the other hand, if it is judged in Step 255 that the received video data does not contain head data of the GOP, the process proceeds to Step 257.

In Step 256, the video server 1 adds a head identifier of the GOP to a head RTP packet for transmitting video data to distribute the video data as an RTP packet (Step 256). Specifically, the video server 1 increments a GOP number by 1 to add it to the RTP packet.

In Step 257, the video server 1 adds a head identifier of a video frame to the head RTP packet for transmitting the video data to distribute the video data as an RTP packet (Step 257). Specifically, the video server 1 adds the GOP number added to the head data of the same GOP to the RTP packet.

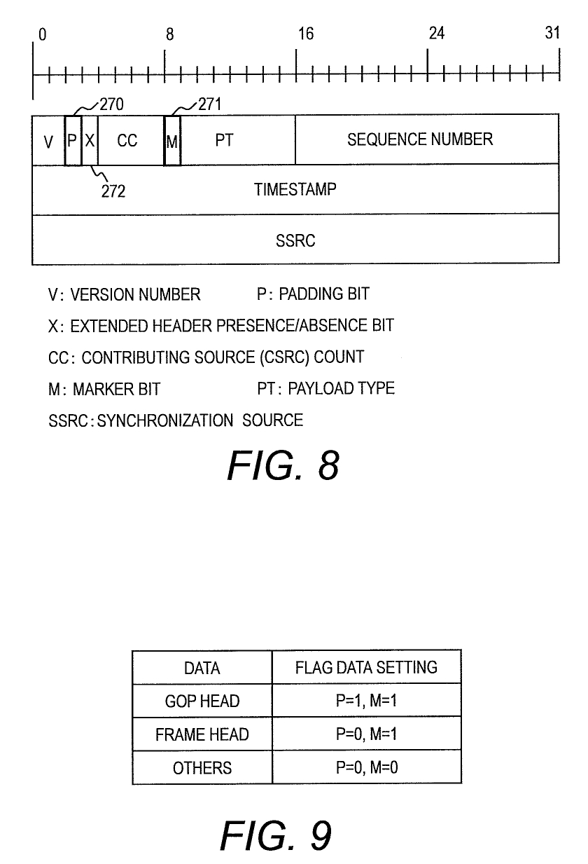

The process of adding the head identifier of the video frame to the RTP packet and the process of adding the head identifier of the GOP to the RTP packet will be described below referring to FIGS. 8 to 11. According to this embodiment, the GOP head data is identified to carry out the process. In the case of forming a sequence for each GOP, however, Step 255 may be executed for each sequence.

FIG. 8 illustrates a configuration of an RTP header according to the first embodiment of this invention.

A P bit 270 of the RTP header is an unused padding area. An M bit 271 is a bit indicating a boundary of video frame data. According to the first embodiment, to notify the video gateway 3 of an RTP packet which contains head data of a GOP or head data of a frame, the P bit 270 and the M bit 271 are used. A specific method for using the P bit 270 and the M bit 271 will be described below referring to FIG. 9.

FIG. 9 illustrates a relation between the P and M bits and heads of GOP and video frame data in the RTP header according to the first embodiment of this invention.

As illustrated in FIG. 9, in the case of an RTP packet for transmitting head data of the GOP, P bit=1 and M bit=1 are set. In the case of an RTP packet for transmitting not a head data of the GOP but head data of a video frame, P bit=0 and M bit=1 are set. In the case of an RTP packet for transmitting data which is not head of the GOP or the video frame, P bit=0 and M bit=0 are set. Thus, whether received video data transmitted by the RTP packet contains head data of the GOP or head of video frame data can be detected.

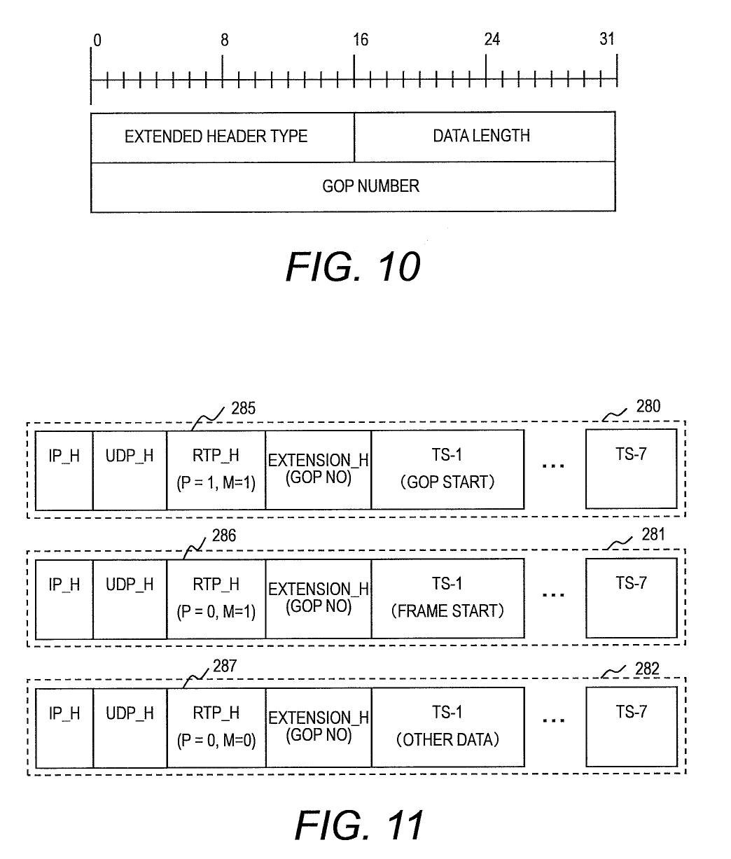

FIG. 10 illustrates a configuration of an extended header of the RTP packet according to the first embodiment of this invention.

The extended header of the RTP packet illustrated in FIG. 10 is used for indicating a sequence number of a GOP.

The extended header of the RTP packet contains a type of an extended header, a data length, and a GOP number. By setting an X bit 272 indicating presence/absence of an extended header of an RTP packet illustrated in FIG. 8 (e.g., X=1 is set), the extended header is made valid to be used.

FIG. 11 illustrates a configuration of a packet where MPEG-2 TS packets are converted into RTP, UDP, and IP packets according to the first embodiment of this invention.

A packet 280 illustrated in FIG. 11 indicates a configuration of an IP packet used for transmitting head data of a new GOP. A packet 281 indicates a configuration of an IP packet used for transmitting not a head data of a GOP but head data of a video frame. A packet 282 indicates a configuration of an IP packet used for transmitting video data which is not head of a GOP or a video frame.

The packet 280 contains an IP header (IP_H), a UDP header (UDP_H), an RTP header (RTP_H), an RTP extended header (extended_H), and MPEG 2-TS-1 to 7. In an RTP header 285, P bit=1 and M bit=1 are set, and a sequence number (GOP number) of a GOP is added to an extended header. The packet 281 is similar in configuration to the packet 280. However, P bit=0 and M bit=1 are set in an RTP header 286, and a sequence number of a GOP is added to an extended header. In the case of GOP video data captured and encoded at the same time, identical GOP numbers are added. The packet 282 is similar in configuration to the packet 280. However, P bit=0 and M bit=0 are set in an RTP header 287, and a sequence number of a GOP is added to an extended header.

In an extended header of an RTP packet for transmitting data belonging to the same GOP, identical GOP numbers are set. The example of FIG. 11 illustrates a configuration where each packet contains 7 MPEG 2-TS packets. However, a configuration where each packet contains the number of MPEG 2-TS packets other than 7 may be employed.

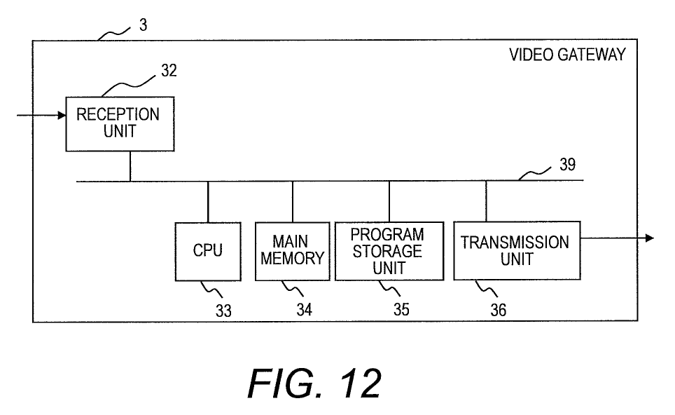

FIG. 12 is a block diagram illustrating a configuration of the video gateway 3 according to the first embodiment of this invention. The video gateway 3 includes a reception unit 32, a CPU 33, a main memory 34, a program storage unit 35, and a transmission unit 36. The reception unit 32, the CPU 33, the main memory 34, the program storage unit 35, and the transmission unit 36 are interconnected via a bus 39.

The reception unit 32 is an interface for receiving video data or meta-data. The CPU 33 executes an operating system (OS) and various application programs. The main memory 34 temporarily stores data necessary when the CPU 33 executes various application programs. In the main memory 34, at least a part of a program stored in the program storage unit 35 is copied when necessary. The program storage unit 35 stores various application programs. The transmission unit 36 is an interface for transmitting a video data or meta-data request.

Next, an operation of the video gateway 3 will be described.

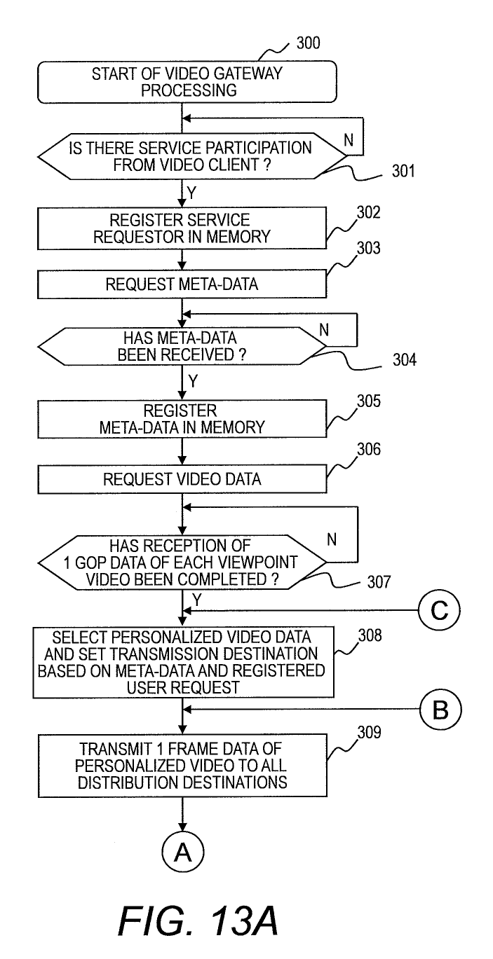

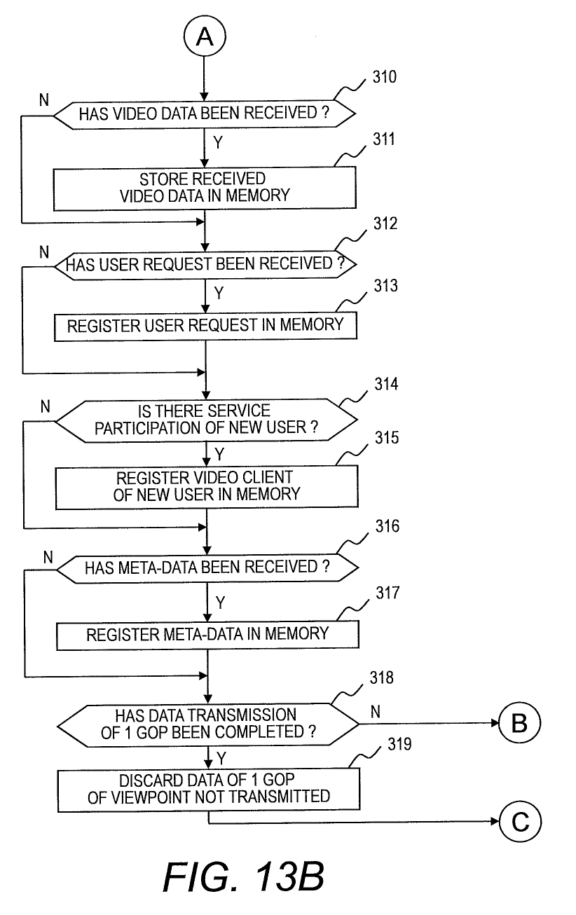

FIG. 13 is a flowchart illustrating a video relaying processing according to the first embodiment of this invention.

The video gateway 3 reads the program stored in the program storage unit 35 to the CPU 33, and the CPU 33 executes the read program to start the video relaying processing (Step 300).

The video gateway 3 judges whether a request of participation in a video distribution service has been received from the video client 4 (Step 301).

If it is judged in Step 301 that a request of participation in the video distribution service has been received from the video client 4, the process proceeds to Step 302. On the other hand, if it is judged in Step 301 that no request of participation in the video distribution service has been received from the video client 4, Step 301 is repeated to judge whether any request of participation in the video distribution service has been received from the video client 4.

The video gateway 3 registers an identifier (e.g., IP address) of a terminal (video client 4) which has transmitted the request of participation in the video distribution service in the main memory 34 (Step 302).

The video gateway 3 transmits a meta-data request to the meta-data server 2 (Step 303).

The video gateway 3 judges whether meta-data has been received from the meta-data server 2 (Step 304).

If it is judged in Step 304 that meta-data has been received from the meta-data server 2, the process proceeds to Step 305. On the other hand, if it is judged in Step 304 that no meta-data has been received from the meta-data server 2, Step 304 is repeated to judge whether meta-data has been received from the meta-data server 2.

The video gateway 3 registers the received meta-data in the main memory 34 (Step 305).

The video gateway 3 transmits a video data distribution request to the video server 1 (Step 306).

The video gateway 3 receives video data transmitted from the video server 1 to judge whether 1 GOP data of video data of each viewpoint has been buffered (Step 307). The number of GOP data whose buffering has to be judged may be changed according to a load on the network (network A 5) between the video server 1 and the video gateway 3. For example, whether 3 GOP data of video data of each viewpoint has been buffered may be judged.

If it is judged in Step 307 that 1 GOP data has been buffered from each viewpoint, the process proceeds to Step 308. On the other hand, if it is judged in Step 307 that 1 GOP data has not been buffered from each viewpoint, Step 307 is repeated to judge whether 1 GOP data of each viewpoint has been buffered.

The video gateway 3 performs setting to distribute video data personalized from received video data of a plurality of viewpoints (Step 308). Specifically, based on the meta-data registered in Step 305 and viewing user's request (user request to be registered in Step 313), the video gateway 3 selects video data of a viewpoint to be distributed. If no user request has been registered, the video gateway 3 selects video data of an initially set viewpoint (e.g., video data of a viewpoint having a smallest viewpoint number among those set for the viewpoints, or video data received at a smallest delay). The video gateway 3 performs setting to distribute the selected video data of the viewpoint to the video client 4 registered in Step 302.

The video gateway 3 transmits 1 frame data of the video data selected as the personalized video in Step 308 to the set distribution destination (Step 309). If there is a plurality of video clients 4 registered to receive the same video data, the video gateway 3 distributes the selected personalized video data to the plurality of registered video clients 4.

The video gateway 3 judges whether video data has been received from the video server 1 (Step 310).

If it is judged in Step 310 that video data has been received from the video server 1, the process proceeds to Step 311. On the other hand, if it is judged in Step 310 that no video data has been received from the video server 1, the process proceeds to Step 312.

The video gateway 3 stores the received video data in the buffer of the main memory 34 (Step 311).

The video gateway 3 judges whether a user request has been received from the video client 4 (Step 312).

If it is judged in Step 312 that a user request has been received from the video client 4, the process proceeds to Step 313. On the other hand, if it is judged in Step 312 that no user request has been received from the video client 4, the process proceeds to Step 314.

The video gateway 3 registers the received user request in the main memory 34 (Step 313).

The video gateway 3 judges whether a service participation request has been received from a new user (Step 314).

If it is judged in Step 314 that a new service participation request has been received, the process proceeds to Step 315. On the other hand, if it is judged in Step 314 that no new service participation request has been received, the process proceeds to Step 316.

The video gateway 3 registers an identifier (e.g., IP address) of a terminal (video client 4) which has transmitted a request of participation in a video distribution service in the main memory 34 (Step 315).

The video gateway 3 judges whether new meta-data has been received from the meta-data server 2 (Step 316).

If it is judged in Step 316 that new meta-data has been received from the meta-data server 2, the process proceeds to Step 317. On the other hand, if it is judged in Step 316 that no new meta-data has been received from the meta-data server 2, the process proceeds to Step 318.

The video gateway 3 registers the received meta-data in the main memory 34 (Step 317).

The video gateway 3 judges whether 1 GOP video data has been distributed (Step 318).

If it is judged in Step 318 that 1 GOP video data has been distributed, the process proceeds to Step 319. On the other hand, if it is judged in Step 318 that no 1 GOP video data has been distributed, the process returns to Step 309.

The video gateway 3 discards, among video data of viewpoints which have not been transmitted, only 1 GOP data of video data having GOP numbers similar to those of the transmitted video data of viewpoints (in other words, deletes only 1 GOP data of the video data) (Step 319). Then, the process returns to Step 308 to continue the personalized video distribution processing.

The process enables switching of the personalized video data in GOP data units. Video data is switched to a next sequence in a GOP data unit based on a sequence number added to each GOP data. Thus, an undisturbed personalized video stream can be played.

Even if GOP data is partially omitted among the video data transmitted from the video server 1, the video data is switched based on the sequence number of the GOP data, and thus continuous synchronization can be realized.

Since each GOP data is synchronized with another, even when a video stream is switched to another, switching back and forth in time can be prevented.

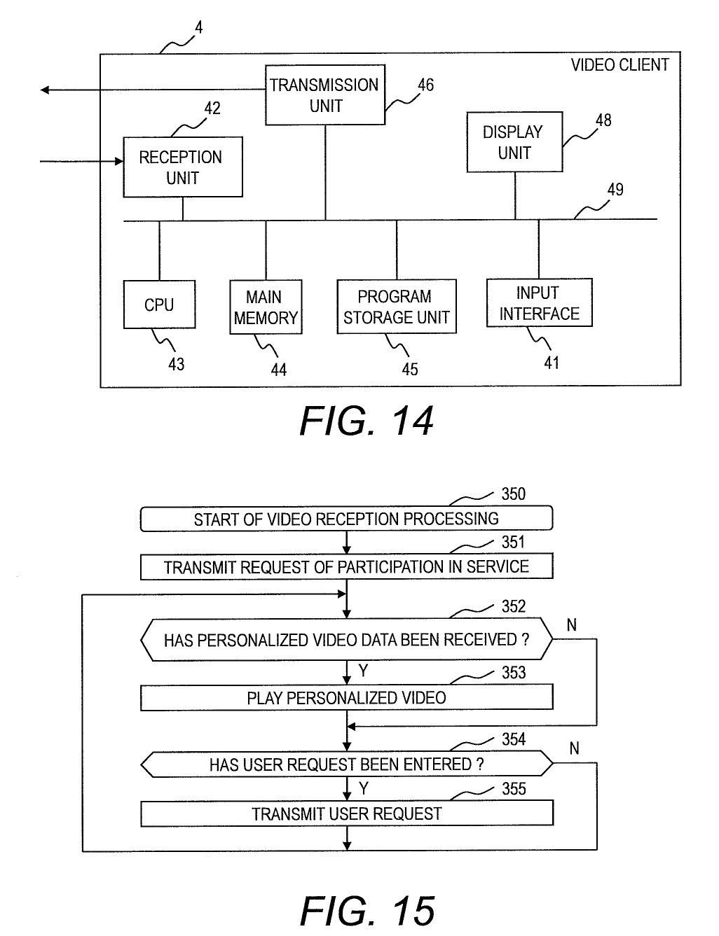

FIG. 14 is a block diagram illustrating a configuration of the video client 4 according to the first embodiment of this invention.

The video client 4 includes a reception unit 42, a transmission unit 46, a display unit 48, a CPU 43, a main memory 44, a program storage unit 45, and an input interface 41. The reception unit 42, the transmission unit 46, the display unit 48, the CPU 43, the main memory 44, the program storage unit 45, and the input interface 41 are interconnected via a bus 49.

The reception unit 42 is an interface for receiving video data. The transmission unit 46 is an interface for transmitting a request of participation in a video distribution service and user request data. The CPU 43 executes an operating system (OS) and various application programs. The main memory 44 temporarily stores data necessary when the CPU 43 executes various application programs. In the main memory 44, at least a part of a program stored in the program storage unit 45 is copied when necessary. The program storage unit 45 stores various application programs. The input interface 41 may include, for example, a keyboard. The display unit 48 displays received video data.

Next, an operation of the video client 4 will be described.

FIG. 15 is a flowchart illustrating a video reception processing according to the first embodiment of this invention.

The video client 4 reads the program stored in the program storage unit 45 to the CPU 43, and the CPU 43 executes the read program to start the video reception processing (Step 350).

First, to receive video data, the video client4 transmits a request of participation in a video transmission service to the video gateway 3 (Step 351).

The video client 4 judges whether personalized video data has been received from the video gateway 3 (Step 352).

If it is judged in Step 352 that personalized video data has been received from the video gateway 3, the process proceeds to Step 353. On the other hand, if it is judged in Step 352 that no personalized video data has been received from the video gateway 3, the process proceeds to Step 354.

The video client 4 plays the received personalized video data (Step 353).

The video client 4 judges whether a user request has been entered from the input interface 41 (Step 354). For example, the video client 4 judges whether user-desired data (“player A”) has been entered.

If it is judged in Step 354 that a user request has been entered, the process proceeds to Step 355. On the other hand, if it is judged in Step 354 that no user request has been entered, the process returns to Step 352 to continue the video reception processing.

The video client 4 transmits the entered user request data to the video gateway 3 (Step 355). Then, the process returns to Step 352 to continue the video reception processing.

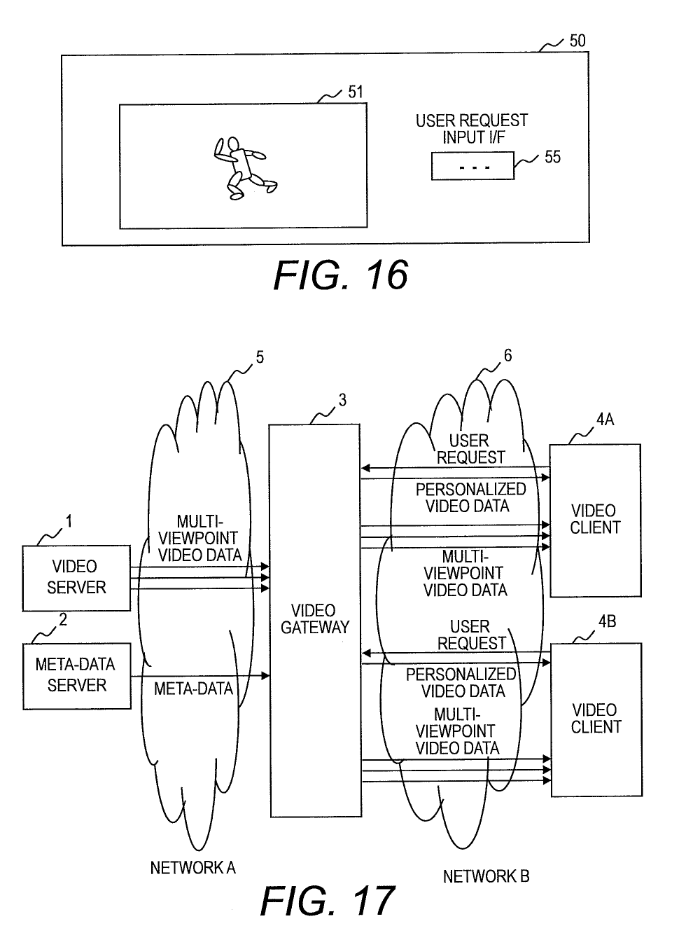

FIG. 16 illustrates a display screen 50 displayed in the display unit 48 of the video client 4 according to the first embodiment of this invention. As illustrated in FIG. 16, the display screen 50 includes a user request input interface 55 for entering viewing user's desire, and a display screen 51 for playing personalized video stream data received from the video gateway 3.

The first embodiment of this invention provides, as illustrated in FIG. 21, a system which switches and distributes video streams (viewpoints) in GOP units among asynchronously received video streams of a plurality of viewpoints. Specifically, when a viewpoint is switched to another, as indicated by a playing flow 460, 1st GOP data of a viewpoint A (GOP-A1) is distributed, and then 2nd GOP data of a viewpoint B (GOP-B2) is distributed. Similarly, viewpoints are sequentially switched in GOP units, and video streams are switched like GOP-C3 and GOP-D4 to be distributed. This embodiment provides this system.

As described above, according to the first embodiment of this invention, video streams are synchronously switched for each unit enabling video stream playing. Thus, switching of video streams can be performed without any disturbance.

A plurality of video streams are received, and synchronized in GOP units. The video data are switched in the synchronized GOP units. Thus, when the video data are switched, no time difference is generated among the video data to be switched, and a personalized video which enables video viewing along a flow of time information can be generated.

User-desired video data is cut out in a GOP unit among a plurality of pieces of video data, thereby generating one personalized video stream. Thus, there is no need to change any video streams (no need to execute application executed by a client again), and video data can be quickly switched to be played.

GOP boundary information is added to the RTP header by using a P bit, and videos are switched in GOP units. Thus, a personalized video can be generated at high speed, and a plurality of personalized videos can be generated with less throughput.

A sequence identifier is added to the RTP extended header in a GOP unit. Thus, even when a packet loss of GOP data occurs, synchronization can be continuously established.

### Second Embodiment

According to the first embodiment of this invention, the video gateway 3 distributes only the personalized video data to the video client 4. According to a second embodiment of this invention, however, a video gateway 3 distributes, in addition to personalized video data, original multi-viewpoint video data received from a video server 1 to a video client 4.

FIG. 17 illustrates a configuration of a video distribution system according to the second embodiment of this invention. A basic system configuration is similar to that of the first embodiment. The second embodiment is different from the first embodiment in that the video gateway 3 transmits the multi-viewpoint video data to the video client 4.

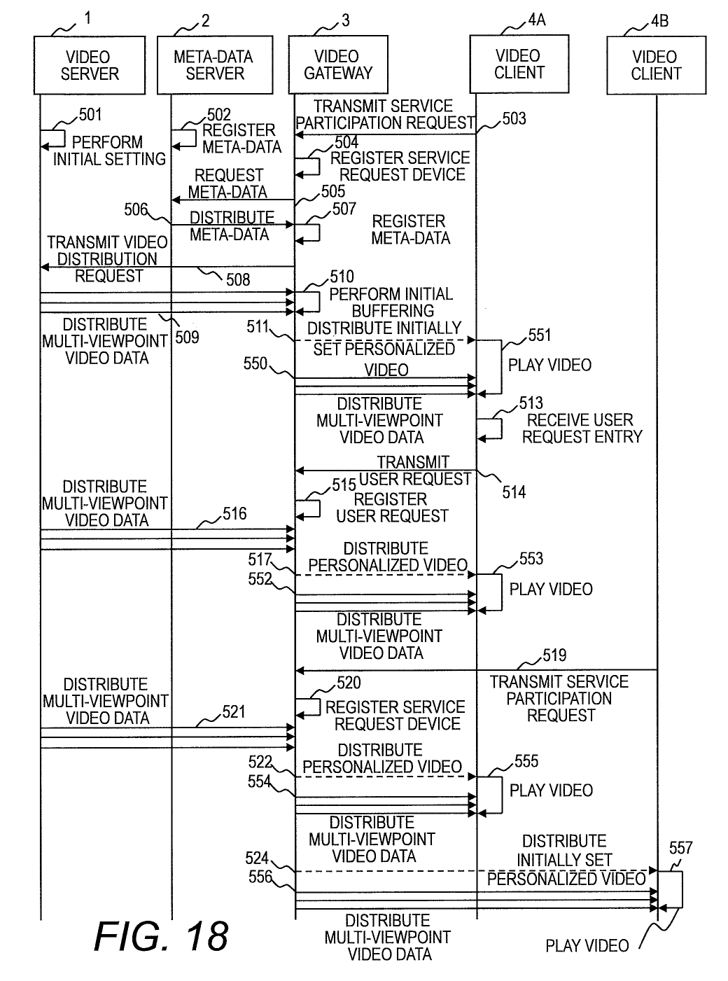

FIG. 18 illustrates a sequence of video stream data transmission/reception processing in the video distribution system according to the second embodiment of this invention.

In the process illustrated in FIG. 18, Steps similar to those of FIG. 2 are denoted by similar numbers. Points different from those of the process illustrated in FIG. 2 will mainly be described below.

The process of Steps 501 to 511 is similar to that of Steps 501 to 511 of FIG. 2.

The video gateway 3 distributes multi-viewpoint video data received from the video server 1 to a video client 4A (Step 550).

The video client 4A plays personalized video data and the multi-viewpoint video data which have been received (Step 551).

The process of Steps 513 to 517 is similar to that of Steps 513 to 517 of FIG. 2.

The video gateway 3 distributes multi-viewpoint video data received from the video server 1 to the video client 4A (Step 552).

The video client 4A plays personalized video data and the multi-viewpoint video data which have been received (Step 553).

The process of Steps 519 to 522 is similar to that of Steps 519 to 522 of FIG. 2.

The video gateway 3 distributes multi-viewpoint video data received from the video server 1 to the video client 4A (Step 554).

The video client 4A plays personalized video data and the multi-viewpoint video data which have been received (Step 555).

Step 524 is similar to Step 524 of FIG. 2.

The video gateway 3 distributes the multi-viewpoint video data received from the video server1 to a video client 4B (Step 556). In the example of FIG. 18, the multi-viewpoint video data is redistributed as video data different from the received multi-viewpoint video. However, when multi-viewpoint video data is distributed by using a multicast method, the same data as that of the received multi-viewpoint video is distributed through multicasting.

The video client 4B plays the personalized video data and the multi-viewpoint video data which have been received (Step 557).

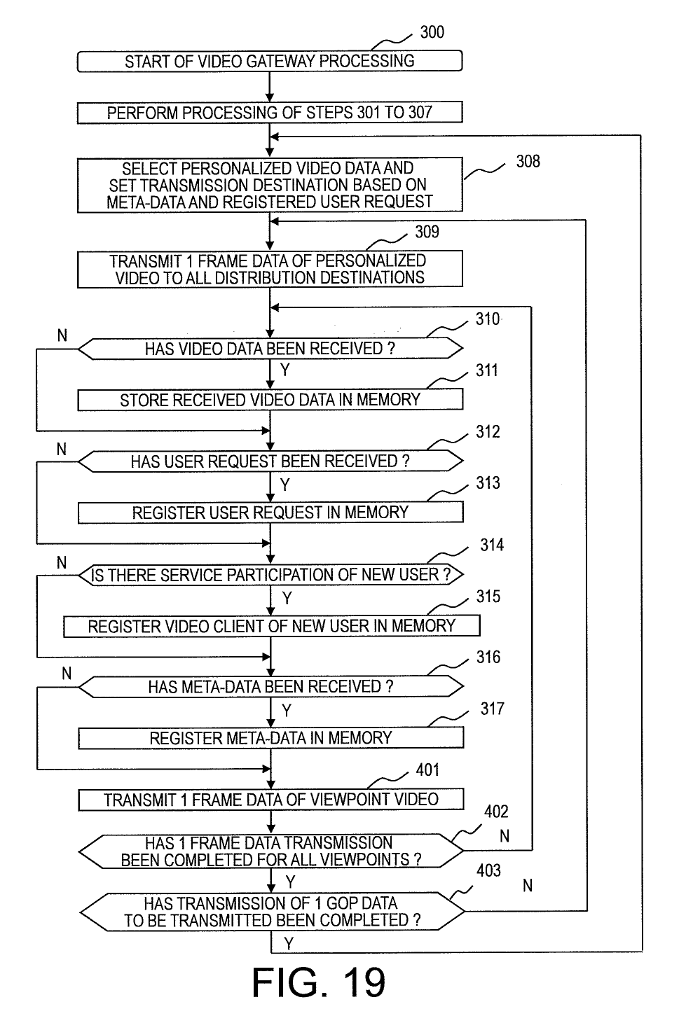

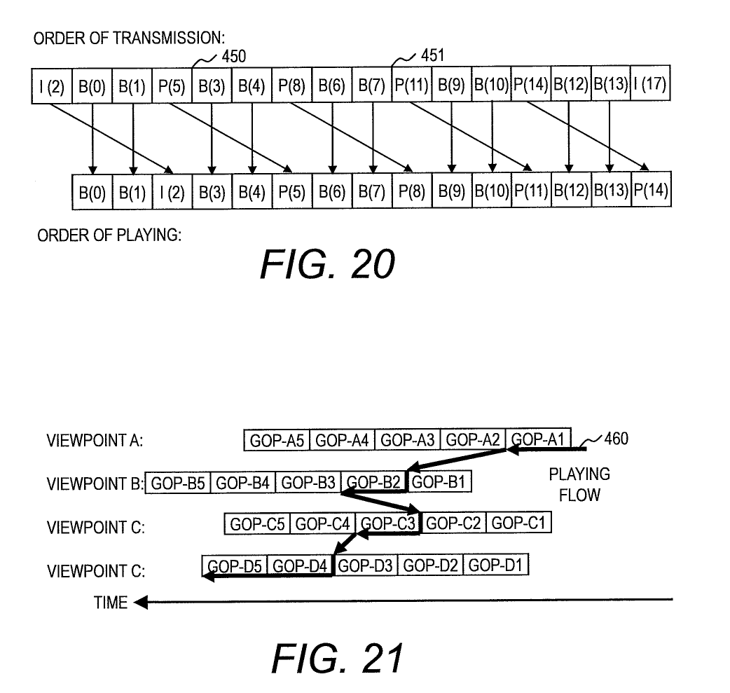

FIG. 19 is a flowchart illustrating video relaying processing according to the second embodiment of this invention. In the video relaying processing of FIG. 13, the video gateway 3 distributes no individual viewpoint video data. However, in the video relaying processing of FIG. 19, the video gateway 3 distributes individual viewpoint video data.

In the process illustrated in FIG. 19, Steps similar to those of FIG. 13 are denoted by similar numbers. Points different from those of the process illustrated in FIG. 13 will mainly be described below.

The process of Steps 300 to 317 is similar to that of Steps 300 to 317 of FIG. 13.

The video gateway 3 distributes individual viewpoint video data (data of 1 frame) to the video client 4 (Step 401). In the case of distributing individual viewpoint video data by using a unicast method, the video gateway 3 distributes the individual viewpoint video data to each video client 4. On the other hand, in the case of distributing individual viewpoint video data by using the multicast method, the video gateway 3 distributes the individual viewpoint video data to the video client through multicasting.

The video gateway 3 judges whether video data of each viewpoint (data of 1 frame) has been distributed to all the video clients 4 (Step 402).

If it is judged in Step 402 that the video data of each viewpoint (data of 1 frame) has been distributed to all the video clients 4, the process proceeds to Step 403. On the other hand, if it is judged in Step 402 that no video data of each viewpoint (data of 1 frame) has been distributed to all the video clients 4, the process returns to Step 310.

The video gateway 3 judges whether video data of 1 GOP among video data to be distributed has been distributed (Step 403).

If it is judged in Step 403 that video data of 1 GOP among the video data to be distributed has been distributed, the process returns to Step 308. If it is judged in Step 403 that no video data of 1 GOP among the video data to be distributed has been distributed, the process returns to Step 309.

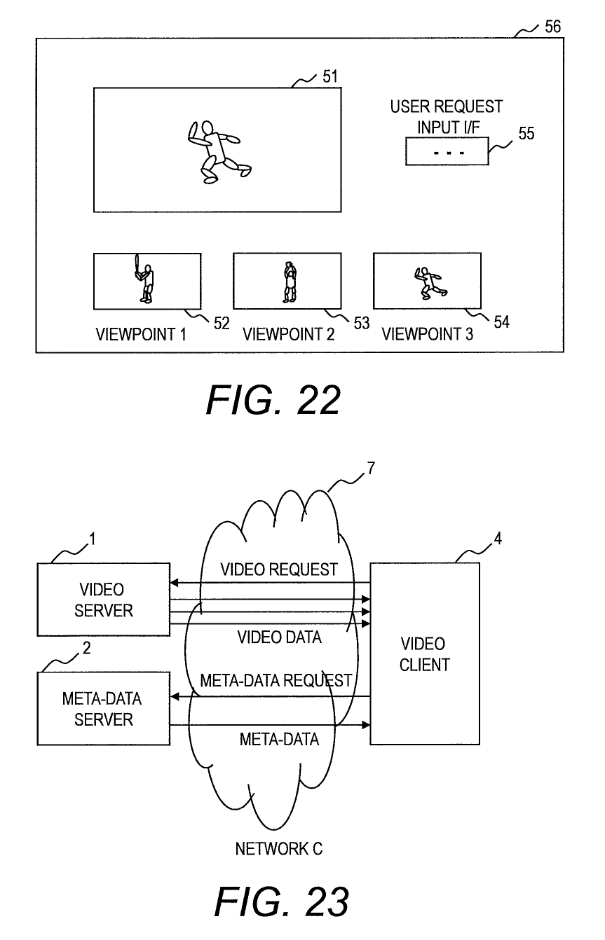

FIG. 22 illustrates a display screen 56 displayed in a display unit 48 of the video client 4 according to the second embodiment of this invention.

As illustrated in FIG. 22, the display screen 56 includes a user request input interface 55 for entering viewing user's desire, a display screen 51 for playing personalized video stream data received from the video gateway 3, and display screens 52 to 54 for playing videos of individual viewpoints.

As described above, according to the second embodiment of this invention, not only an undisturbed personalized video can be played but also individual video streams can be played simultaneously.

### Third Embodiment

FIG. 23 illustrates a configuration of a video distribution system according to a third embodiment of this invention.

The video distribution system of the third embodiment includes a video server 1, a meta-data server 2, and a video client 4. A network C 7 interconnects the video server 1, the meta-data server 2, and the video client 4.

The video server 1 receives a video distribution request from the video client 4, and distributes a multi-viewpoint video stream to the video client 4. The meta-data server 2 receives a meta-data request from the video client 4, and distributes meta-data indicating a content of a video stream to be distributed to the video client 4.

The video client 4 transmits a video distribution request to the video server 1, and receives video data transmitted from the video server 1. The video client 4 transmits a meta-data request to the meta-data server 2, and receives meta-data transmitted from the meta-data server 2. The video client 4 receives a request from a user, selects video data matching the received meta-data and the request received from the user, and outputs the selected video data. Then, the output video data is played by a display unit 48.

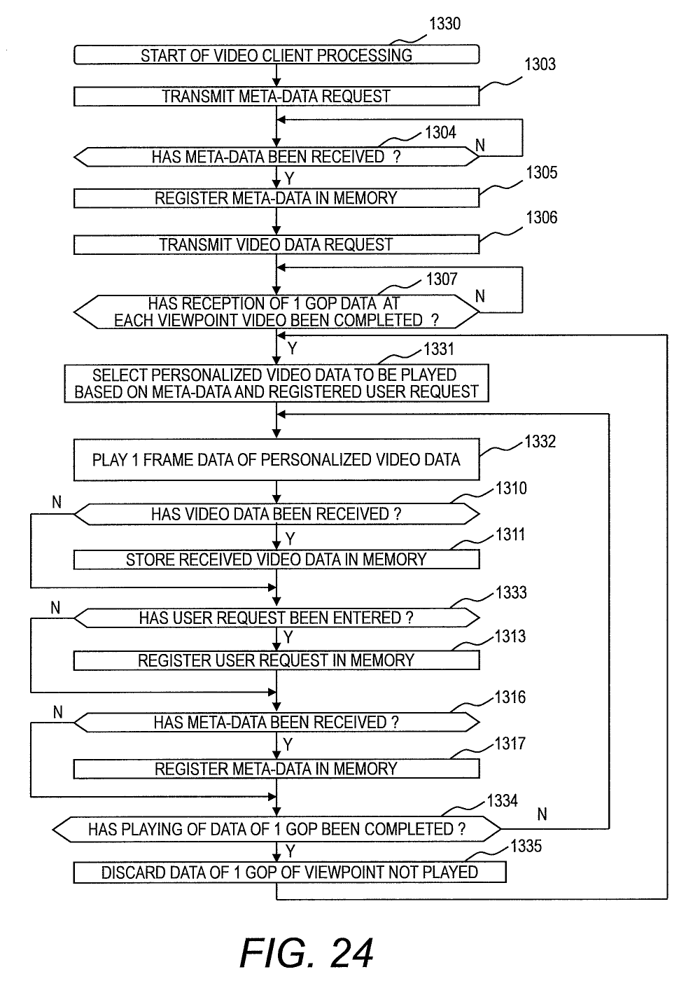

FIG. 24 is a flowchart illustrating video reception processing according to the third embodiment of this invention.

The video client 4 reads a program stored in a program storage unit 45 to a CPU 43. The CPU 43 executes the read program, thereby starting the video reception processing (Step 1330).

The video client4 transmits a meta-data request to the meta-data server 2 (Step 1303).

The video client 4 judges whether meta-data has been received from the meta-data server 2 (Step 1304).

If it is judged in Step 1304 that meta-data has been received from the meta-data server 2, the process proceeds to Step 1305. On the other hand, if it is judged in Step 1304 that no meta-data has been received from the meta-data server 2, Step 1304 is repeated to judge whether meta-data has been received from the meta-data server 2.

The video client 4 registers the received meta-data in a main memory 44 (Step 1305).

The video client 4 transmits a video data distribution request to the video server 1 (Step 1306).

The video client 4 receives video data transmitted from the video server 1 to judge whether 1 GOP data of video data of each viewpoint has been buffered (Step 1307).

If it is judged in Step 1307 that 1 GOP data of the video data of each viewpoint has been buffered, the process proceeds to Step 1331. On the other hand, if it is judged in Step 1307 that 1 GOP data of the video data of each viewpoint has not been buffered, Step 1307 is repeated to judge whether 1 GOP data of the video data of each viewpoint has been buffered.

The video client 4 performs setting to generate video data personalized from received video data of a plurality of viewpoints (Step 1331). Specifically, based on the meta-data registered in Step 1305 and viewing user's request (user request to be registered in Step 1313), the video client 4 performs setting of video data of a viewpoint to be selected. If no user request has been registered, the video client 4 selects video data of an initially set viewpoint (e.g., video data of a viewpoint having a smallest viewpoint number among those set for the viewpoints).

The video client 4 plays 1 frame video data of the personalized video selected in Step 1331 (Step 1332).

The video client 4 judges whether video data has been received from the video server 1 (Step 1310).

If it is judged in Step 1310 that video data has been received from the video server 1, the process proceeds to Step 1311. On the other hand, if it is judged in Step 1310 that no video data has been received from the video server 1, the process proceeds to Step 1333.

The video client 4 stores the received video in the buffer of the main memory 44 (Step 1311).

The video client 4 judges whether a user request has been entered (Step 1333).

If it is judged in Step 1333 that a user request has been entered, the process proceeds to Step 1313. On the other hand, if it is judged in Step 1333 that no user request has been entered, the process proceeds to Step 1316.

The video client 4 registers the entered user request in the main memory 44 (Step 1313). Next, the video client 4 judges whether new meta-data has been received from the meta-data server 2 (Step 1316).

If it is judged in Step 1316 that new meta-data has been received from the meta-data server 2, the process proceeds to Step 1317. On the other hand, if it is judged in Step 1316 that no new meta-data has been received from the meta-data server 2, the process proceeds to Step 1334.

The video client 4 registers the received meta-data in the main memory 34 (Step 1317).

The video client 4 judges whether 1 GOP video data has been played (Step 1334).

If it is judged in Step 1334 that 1 GOP video data has been played, the process proceeds to Step 1335. On the other hand, if it is judged in Step 1334 that no 1 GOP video data has been played, the process returns to Step 1332.

The video client 4 discards, among video data of viewpoints which have not been played, only 1 GOP data of video data having GOP numbers similar to those of the played video data of viewpoints (Step 1335). Then, the process returns to Step 1331 to continue the personalized video generation and playing processing.

As described above, according to the third embodiment of this invention, the video client 4 can generate personalized video data to play the personalized video data.

### Fourth Embodiment

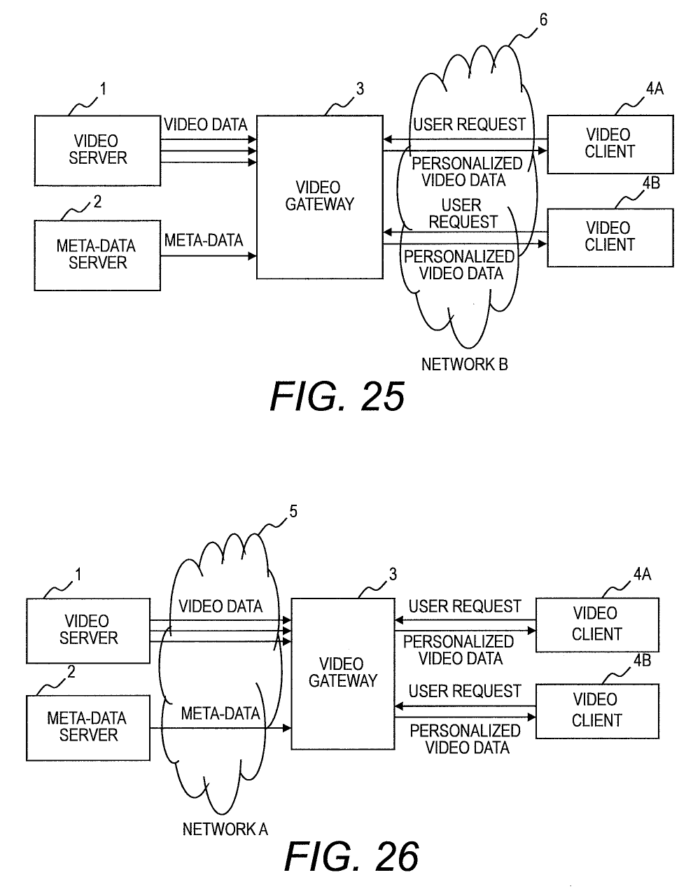

FIG. 25 illustrates a configuration of a video distribution system according to a fourth embodiment of this invention.

An operation of the video distribution system illustrated in FIG. 25 is similar to that of the video distribution system of FIG. 1. As illustrated in FIG. 25, however, by directly interconnecting a video server 1, a meta-data server 2, and a video gateway 3 without using any network, or by installing the video server 1, the meta-data server 2, and the video gateway 3 in one point, devices installed on a video distribution side can be managed altogether, thereby reducing maintenance loads. For example, the video server 1, the meta-data server 2, and the video gateway 3 may use one shared memory to realize a system. Those devices may be interconnected by a cable such as a USB cable. The video server 1, the meta-data server 2, and the video gateway 3 may be configured in the same hardware, and interconnected by a bus.

### Fifth Embodiment

FIG. 26 illustrates a configuration of a video distribution system according to a fifth embodiment of this invention.

An operation of the video distribution system illustrated in FIG. 26 is similar to that of the video distribution system of FIG. 1. As illustrated in FIG. 26, however, by interconnecting a video gateway 3 and a video client 4 without using any network, a response can be made faster to a request from the video client 4. Preferably, the video gateway 3 and the video client 4 are interconnected by the same connection method (e.g., IEEE 1394). A system may be configured such that the video gateway 3 is installed at a house entrance, and the video client 4 is installed in each room.

### Sixth Embodiment

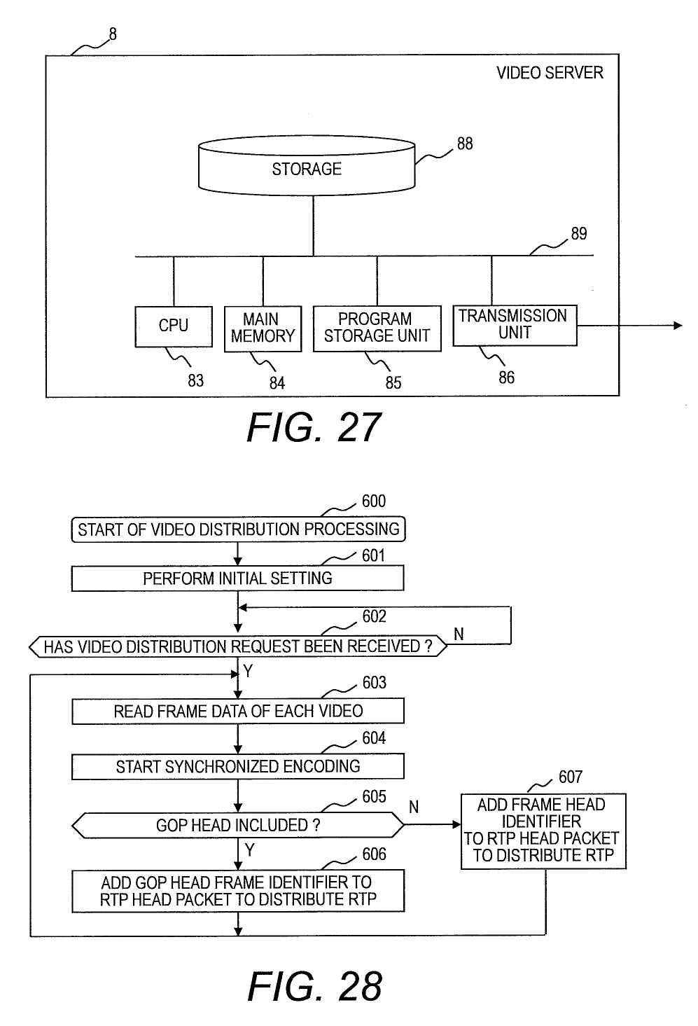

FIG. 27 is a block diagram illustrating a configuration of a video v8 according to a sixth embodiment of this invention. The video server 8 of the sixth embodiment is a modified example of the video server 1 of the first embodiment. The video server 8 includes a storage 88, a CPU 83, a main memory 84, a program storage unit 85, and a transmission unit 86. The storage 88, the CPU 83, the main memory 84, the program storage unit 85, and the transmission unit 86 are interconnected via a bus 89.

The storage 88 stores a plurality of pieces of captured video data. The CPU 83 executes an operating system (OS) and various application programs. The main memory 84 temporarily stores data necessary when the CPU 83 executes various application programs. In the main memory 84, at least a part of a program stored in the program storage unit 85 is copied when necessary. The program storage unit 85 stores various application programs. The transmission unit 86 is an interface for distributing encoded video data via a network.

Next, an operation of the video server 8 will be described.

FIG. 28 is a flowchart illustrating video distribution processing according to the sixth embodiment of this invention.

The video server8 reads the program stored in the program storage unit 85 to the CPU 83. The CPU 83 executes the read program, thereby starting the video distribution processing (Step 600).

First, the video server 8 performs 0-value initial setting of a GOP number to distribute video data (Step 601).

The video server 8 judges whether a video distribution request has been received from a video gateway 3 (Step 602).

If it is judged in Step 602 that a video distribution request has been received from the video gateway 3, the process proceeds to Step 603. On the other hand, if it is judged in Step 602 that no video distribution request has been received from the video gateway 3, Step 602 is repeated to judge whether a video distribution request has been received from the video gateway 3.

The video server 8 reads 1 frame data of video data of each viewpoint from the video data stored in the storage 88 (Step 603).

The video server 8 encodes video data of a plurality of viewpoints in synchronization (Step 604). Specifically, the video server 8 matches GOP numbers added to the video data of respective viewpoints to compress and encode the video data of the respective viewpoints. If the video data stored in the storage 88 and the video data to be distributed from the video server 8 are similar to each other in format, the process proceeds to Step 605 without executing Step 604.

For example, when there is video data of a format of MPEG 2 stored in the storage 88, and video data is transmitted based on MPEG 2, re-encoding is not necessary. Thus, the process proceeds to Step 605 without executing Step 604. In the case of video data whose frame has been predicted over a plurality of GOP's, re-encoding has to be performed to predict a frame in GOP units in Step 604, thereby enabling its application to this invention.

The video server 8 judges whether the video data encoded in Step 604 contains head data of the GOP (Step 605).

If it is judged in Step 605 that the encoded video data contains head data of the GOP, the process proceeds to Step 606. On the other hand, if it is judged in Step 605 that the encoded video data does not contain head data of the GOP, the process proceeds to Step 607.

In Step 606, the video server 8 adds a head identifier of the GOP to a head RTP packet for transmitting video data to distribute the video data as an RTP packet (Step 606). Specifically, the video server 8 increments a GOP number by 1 to add it to the RTP packet.

In Step 607, the video server 8 adds a head identifier of a video frame to the head RTP packet for transmitting the video data to distribute the video data as an RTP packet (Step 607). Specifically, the video server 8 adds the GOP number added to the head data of the same GOP to the RTP packet.

### Seventh Embodiment

According to the first embodiment of this invention, based on the user request data, the video gateway 3 distributes the personalized video data to the video client 4. According to a seventh embodiment of this invention, however, a video gateway 3 first generates selectable video streams, and transmits keywords for selecting the generated video streams to a video client 4. A user selects one for a request among the transmitted keywords, and the selected keyword is transmitted to the video gateway 3.

For example, in the case of distributing video data of baseball broadcasting by using a system of the seventh embodiment, the video gateway 3 provides video services, i.e., first generating a video stream for a user who favors a first-batting team, and a video stream for a user who favors a second-batting team, and then enabling a user to select a favorite one of the first-batting and second-batting teams.

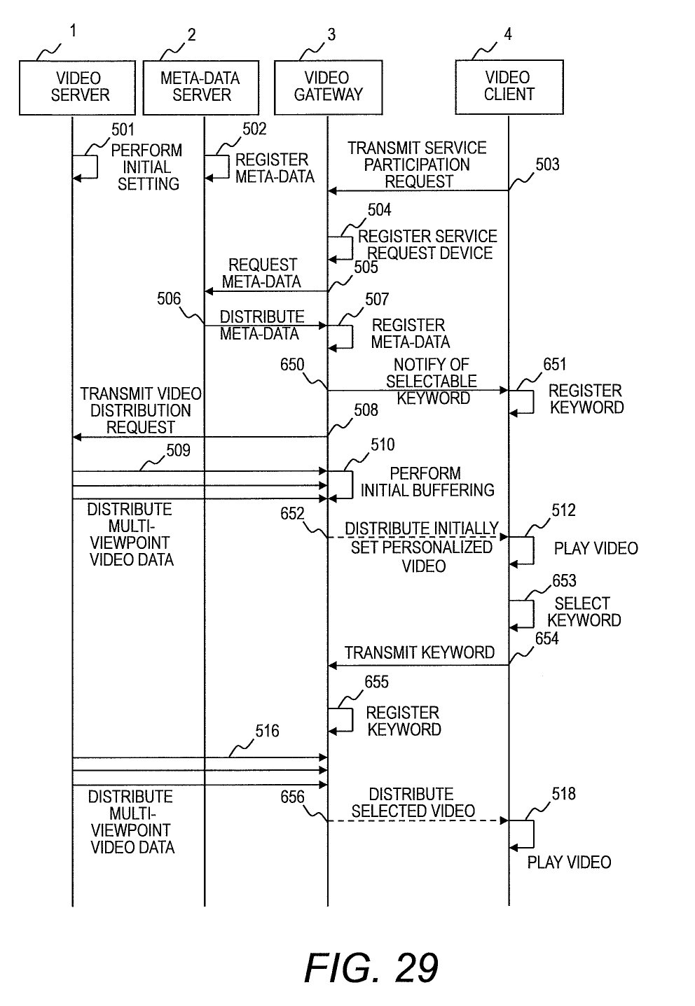

FIG. 29 illustrates a sequence of video stream data transmission/reception process of a video distribution system according to the seventh embodiment of this invention.

In the process illustrated in FIG. 29, Steps similar to those of FIG. 2 are denoted by similar numbers. Points different from those of FIG. 2 will mainly be described below.

The process of Steps 501 to 507 is similar to that of Steps 501 to 507 illustrated in FIG. 2.

Then, the video gateway 3 transmits keywords for selecting video streams generated beforehand to the video client 4 (Step 650).

The video client 4 registers the received keywords to enable selection thereof from, for example, the user request input interface illustrated in FIG. 16 (Step 651).

The process of Steps 508 to 510 is similar to that of Steps 508 to 510 illustrated in FIG. 2.

Then, the video gateway 3 distributes initially set selected video data to the video client 4 according to initial setting designated beforehand (e.g., “neutral video”: in the case of baseball broadcasting, video generated by switching videos of first-batting and second-batting teams by about the same level) (Step 652).

Step 512 is similar to Step 512 of FIG. 2.

The video client 4 detects a keyword selected by the user (Step 653).

The video client 4 transmits the keyword detected in Step 653 to the video gateway 3 (Step 654).

The video gateway 3 receives the keyword transmitted from the video client 4 in Step 654 to register the received keyword (Step 655).

Step 516 is similar to Step 516 of FIG. 2.

The video gateway 3 selects, based on the keyword (e.g., “first-batting team”) registered in Step 655, a video stream generated corresponding to the keyword to transmit it to the video client 4 (Step 656).

Step 518 is similar to Step 518 of FIG. 2.

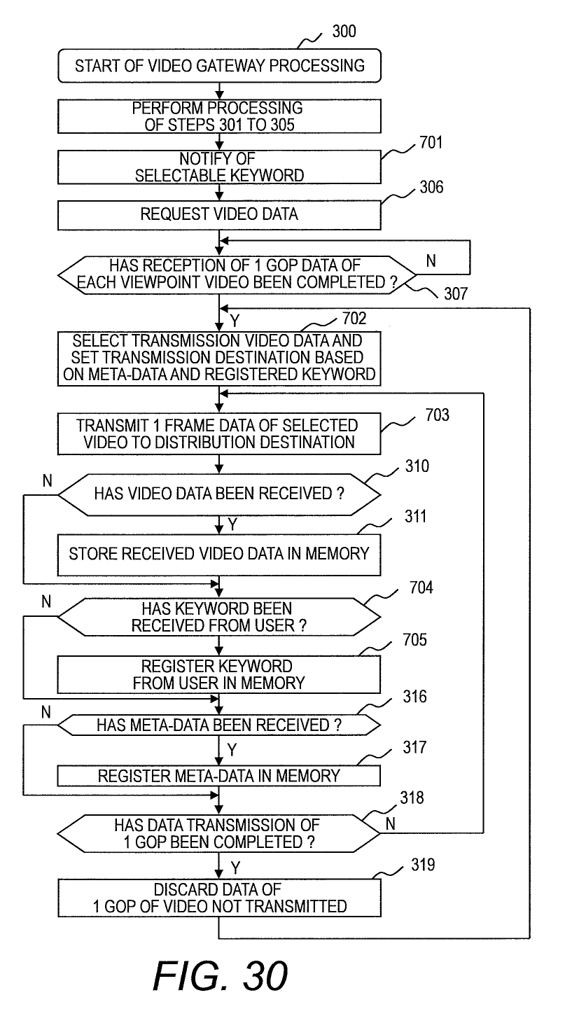

FIG. 30 is a flowchart illustrating video relaying processing according to the seventh embodiment of this invention.

In the process illustrated in FIG. 30, Steps similar to those of FIG. 13 are denoted by similar numbers. Points different from those of FIG. 13 will mainly be described below.

The process of Steps 300 to 305 is similar to that of Steps 300 to 305 illustrated in FIG. 13.

Then, the video gateway 3 notifies the video client 4 of keywords corresponding to pre-selectable video streams (Step 701).

The process of Steps 306 and 307 is similar to that of Steps 306 and 307 of FIG. 2.

The video gateway 3 generates a pre-selectable video stream (e.g., “neutral video”, “video for user who favors first-batting team”, or “video for user who favors second-batting team”) from received video data of a plurality of viewpoints, and specifies a terminal (video client 4) for receiving a selectable video (Step 702).

The video gateway 3 distributes, based on a keyword selected by a user, 1 frame data of video data corresponding to the keyword to the distribution destination set in Step 702 (Step 703).

The process of Steps 310 and 311 is similar to that of Steps 310 and 311 illustrated in FIG. 13.

The video gateway 3 judges whether the keyword selected by the user has been received from the video client 4 (Step 704).

If it is judged in Step 704 that the keyword selected by the user has been received from the video client 4, the process proceeds to Step 705. On the other hand, if it is judged in Step 704 that the keyword selected by the user has not been received from the video client 4, the process proceeds to Step 316.

The video gateway 3 associates the received keyword with the terminal (video client 4) which has requested video distribution to register it in a main memory 34 (Step 705).

The process of Steps 316 to 319 is similar to that of Steps 316 to 319 illustrated in FIG. 13.

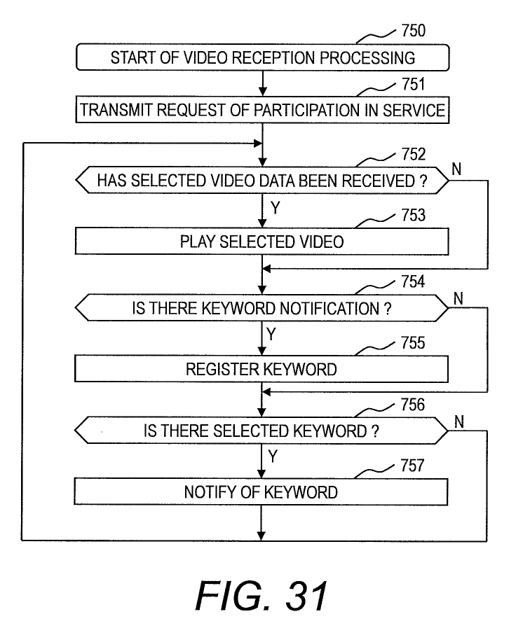

FIG. 31 is a flowchart illustrating video reception processing according to the seventh embodiment of this invention.

The video client 4 reads a program stored in a program storage unit 45 to a CPU 43, and the CPU 43 executes the read program, thereby starting the video reception processing (Step 750).

First, to receive video data, the video client 4 transmits a request of participation in a video transmission service to the video gateway 3 (Step 751).

The video client 4 judges whether selected video data has been received from the video gateway 3 (Step 752).

If it is judged in Step 752 that selected video data has been received from the video gateway 3, the process proceeds to Step 753. On the other hand, if it is judged in Step 752 that no selected video data has been received from the video gateway 3, the process proceeds to Step 754.

The video client 4 plays the received video data (Step 753).

The video client 4 judges whether a keyword for selecting video data has been received from the video gateway 3 (Step 754).

If it is judged in Step 754 that a keyword has been received from the video gateway 3, the process proceeds to Step 755. On the other hand, if it is judged in Step 754 that no keyword has been received from the video gateway 3, the process proceeds to Step 756.

The video client 4 registers the received keyword in a main memory 44 (Step 755).

The video client 4 judges whether a user-desired keyword has been selected from an input interface 41 (Step 756). In other words, the video client 4 judges whether a user-desired video (video for user who favors first-batting team) has been entered.

If it is judged in Step 756 that a user-desired keyword has been selected from the input interface 41, the process proceeds to Step 757. On the other hand, if it is judged in Step 752 that no user-desired keyword has been selected from the input interface 41, the process returns to Step 752 to continue the video reception processing.

The video client 4 transmits the selected keyword to the video gateway 3 (Step 757).

### Eighth Embodiment

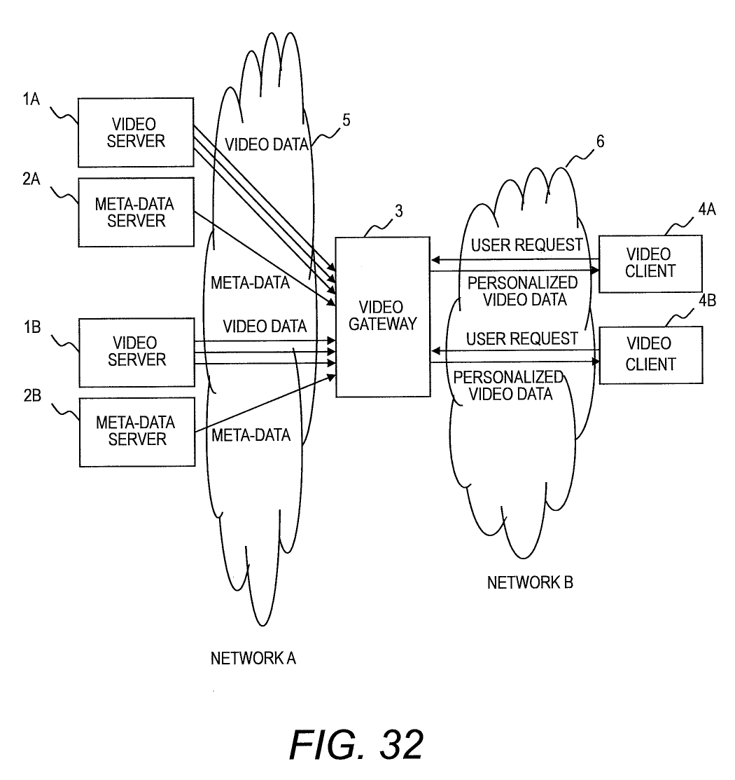

FIG. 32 illustrates a configuration of a video distribution system according to an eighth embodiment of this invention.

The video distribution system of the eighth embodiment includes a plurality of video server 1 and a plurality of meta-data servers 2 (video servers 1A and 1B and meta-data servers 2A and 2B), each of which is similar to that of the video distribution system of the first embodiment illustrated in FIG. 1. Hereinafter, the video servers 1A and 1B and the meta-data servers 2A and 2B may be collectively referred to as a video server 1 and a meta-data server 2, respectively.

The video distribution system of the first embodiment can be used for broadcasting a competitive sport such as baseball or soccer played in one playing field. On the other hand, because of its inclusion of the pluralities of video servers 1 and meta-data servers 2, the video distribution system of the eighth embodiment can be used for a large-scale video distribution system over a plurality of points. For example, by installing pluralities of video servers 1 and meta-data servers 2 in business offices of a large corporation having a plurality of business offices, situations of the business offices can be checked from a video client 4 of a remote place. A system can be provided, which checks a video of an employee whose situation is to be checked by distributing a video of a specific business office through meta-data.

### Ninth Embodiment

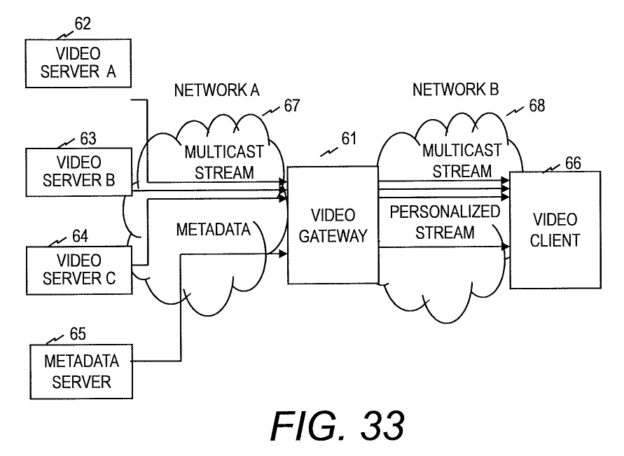

FIG. 33 illustrates a configuration of a video distribution system according to a ninth embodiment of this invention.

The video distribution system of the ninth embodiment includes a video gateway 61, video servers A to C (62 to 64), a metadata server 65, and networks A 67 and B 68. A video client 66 is connected to the network B 68.

The network A 67 interconnects the video gateway 61, the video A to C (62 to 64), and the metadata server 65. The network B 68 interconnects the video gateway 61 and the video client 66.

<Video Gateway>

First, the video gateway 61 will be described.

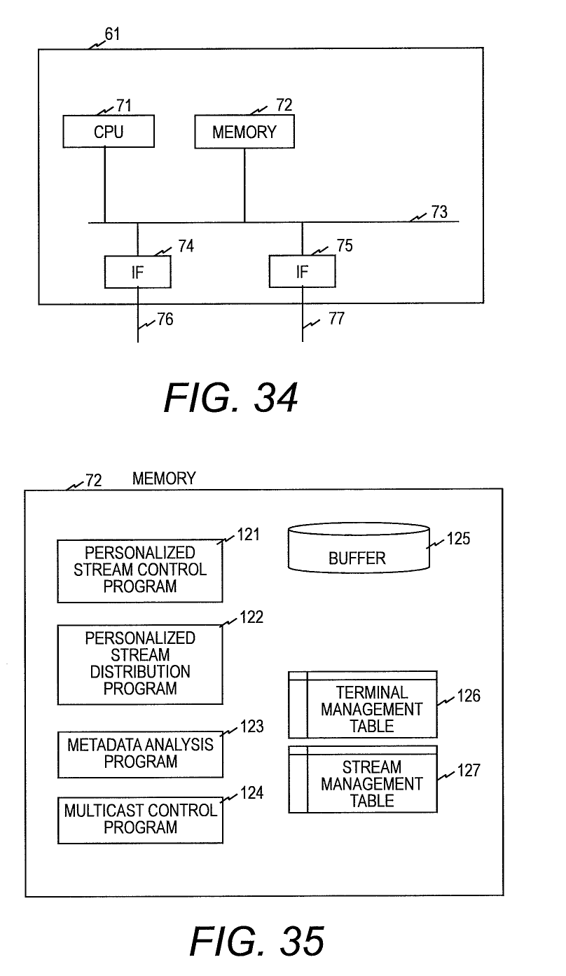

FIG. 34 is a block diagram illustrating a configuration of the video gateway 61 according to the ninth embodiment of this invention.

The video gateway 61 includes a central processing unit (CPU) 71, a memory 72, and interfaces 74 and 75.

The CPU 71 executes an operating system (OS) and various application programs. The memory 72 stores various application programs executed by the CPU 71. The CPU 71 and the memory 72 are interconnected via a bus 73.

The interfaces 74 and 75 transmit data from the CPU 71 and the memory 72 to an external device via the network, and receive data from the external device. The interfaces 74 and 75 are respectively connected to a line 76 connected to the network A 67 and a line 77 connected to the network B 68.

FIG. 35 illustrates a configuration of the memory 72 of the video gateway 61 according to the ninth embodiment.

The memory 72 of the video gateway 61 stores a personalized stream control program 121, a personalized stream distribution program 122, a metadata analysis program 123, a multicast control program 124, a buffer 125, a terminal management table 126, and a stream management table 127.

The personalized stream control program 121 receives a notification sent from the video client 66, and updates the terminal management table 126 based on the received notification.

The personalized stream distribution program 122 generates a personalized stream to be sent to the video client 66 from a plurality of video streams transmitted from the video servers A to C (62 to 64), and transmits the generated personalized stream to the video client 66.

The metadata analysis program 123 receives a metadata notification sent from the metadata server 65, and selects a personalized stream to be sent to the video client 66 based on the received metadata notification.

The multicast control program 124 receives a multicast control request (IGMP report) from the video client 66, and transfers the received multicast control request to a multicast router in the network A 67. The multicast control program 124 receives a multicast control request (IGMP query) sent from the multicast router, and transfers the received multicast control request to the video client 66.

The buffer 125 temporarily stores the video streams sent from the video servers A to C (62 to 64).

The terminal management table 126 holds information of the video client 66. When a plurality of clients are present, a terminal management table is held for each client.

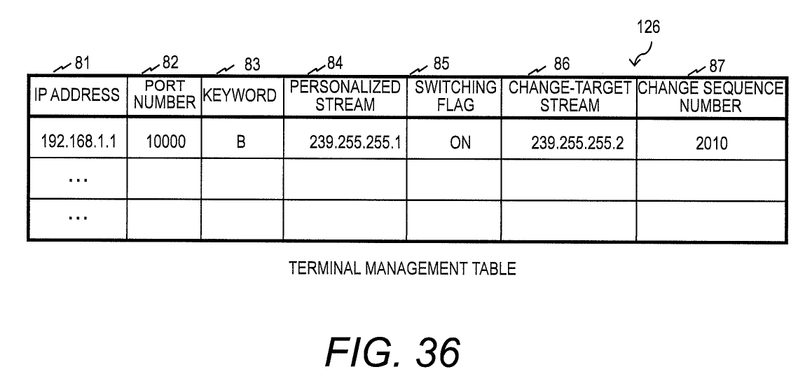

FIG. 36 illustrates a configuration example of the terminal management table 126 according to the ninth embodiment of this invention.

The terminal management table 126 includes an IP address 81, a port number 82, a keyword 83, a personalized stream 84, a switching flag 85, a change-target stream 86, and a change sequence number 87.

The IP address 81 is an IP address of the video client 66. The port number 82 is a port number for waiting for a personalized stream. The keyword 83 is a keyword used for selecting a personalized stream. In place of the keyword, an identifier of the selected personalized stream may be registered.

The personalized stream 84 is an identifier of a video stream currently selected as a personalized stream (destination address of a multicast group to which the selected video stream is distributed) among the streams distributed from the video servers.

The switching flag 85 is a flag for reserving switching of a stream to be selected. The change-target stream 86 is an IP address of the change-target stream reserved for switching. The change sequence number 87 is a sequence number of a changing point.

The stream management table 127 manages information of the video streams sent from the video servers A to C (62 to 64).

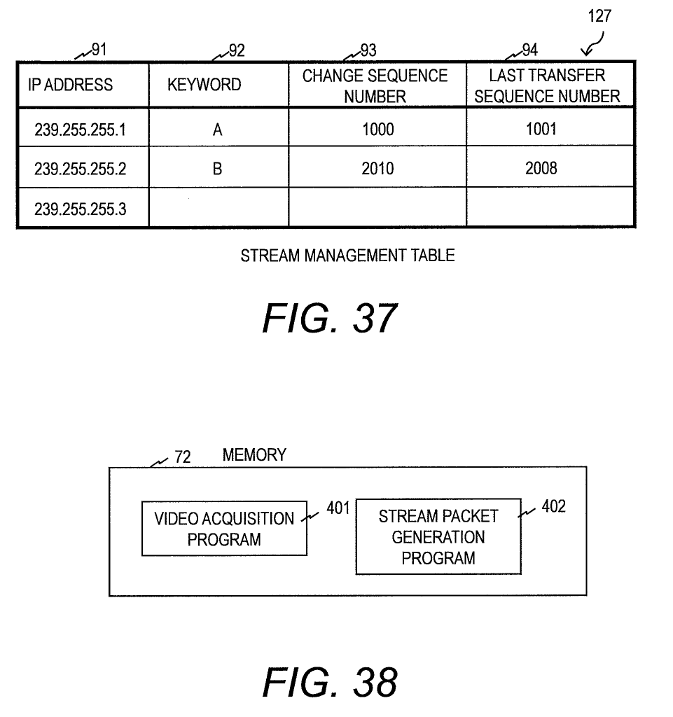

FIG. 37 illustrates a configuration example of the stream management table 127 according to the ninth embodiment of this invention.

The stream management table 127 includes an IP address 91, a keyword 92, a change sequence number 93, and a last transfer sequence number 94.

The IP address 91 is an IP address of a destination of the video streams sent from the video servers. The keyword 92 is a video keyword to be added as additional information to a video. The change sequence number 93 is a sequence number at which the video indicated by the keyword starts. The last transfer sequence number 94 is a sequence number of a last processed stream.

<Video Server>

Next, the video servers A to C (62 to 64) will be described.

The video server A 62 has a hardware configuration similar to that of the video gateway 61 illustrated in FIG. 34. In other words, the video server A 62 includes the CPU 71, the memory 72, the bus 73, and the interface 74. The interface 74 is connected to the line 76 connected to the network A 67. The video server A 62 does not include the interface 75.

FIG. 38 illustrates a configuration of the memory 72 of each of the video servers A to C (62 to 64) according to the ninth embodiment of this invention.

The memory 72 of the video server stores a video acquisition program 401 and a stream packet generation program 402.

The video acquisition program 401 obtains video data from a capturing device (not shown) such as a camera connected to the video server or a medium (not shown) storing the video data.

The stream packet generation program 402 analyzes a configuration of the video obtained by the video acquisition program 401 to generate a stream packet to be transmitted to the network A 67.

The configuration of the video server A 62 has been described. The video servers B and C (63 and 64) are similar in configuration to the video server A 62.

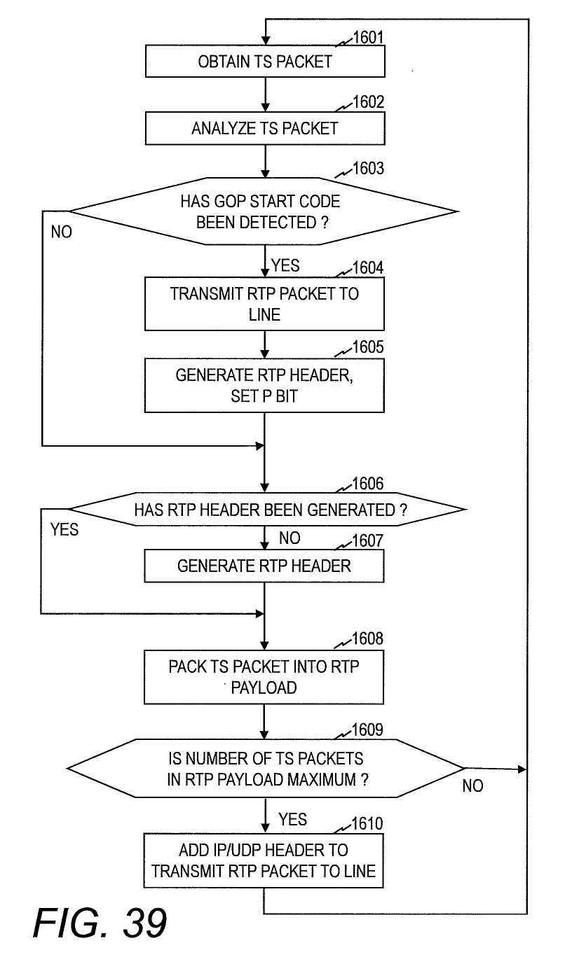

FIG. 39 is a flowchart illustrating stream packet generation processing executed by the stream packet generation program 402 according to the ninth embodiment of this invention.

In the stream packet generation processing, when a TS packet of MPEG 2 is obtained from the video acquisition program 401 (Step 1601), whether the obtained TS packet contains a GOP start code is analyzed (Step 1602).

If a result shows that the obtained TS packet contains a GOP start code (“YES” in Step 1603), an RTP packet which has been generated is output to the line 76 (Step 1604). Then, a new RTP header is generated to set “1” in a predetermined area (Step 1605). For the predetermined area, a P bit 78 prepared as a padding area in the RTP header may be used.

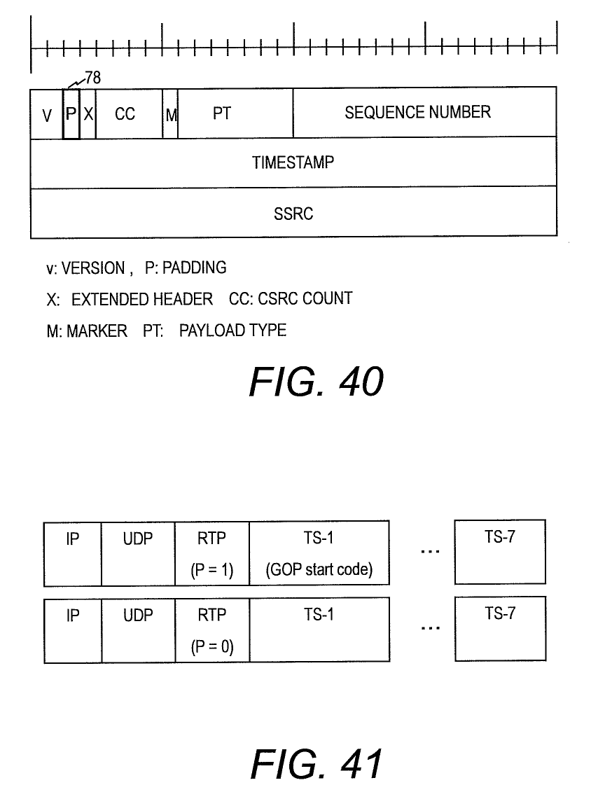

FIG. 40 illustrates a configuration of the RTP header according to the ninth embodiment of this invention. The P bit 78 of the RTP header is an unused padding area. According to the ninth embodiment, this padding area is used for notifying the video server 61 of the RTP packet which contains a GOP head.

On the other hand, if no GOP start code is detected in the obtained TS packet in Step 1603, the process proceeds to Step 1606.

In Step 1606, whether an RTP header has been generated is judged. If no RTP header has been generated, an RTP header is generated (Step 1607). On the other hand, if an RTP header has been generated, the process proceeds to Step 1608.

In Step 1608, the TS packet is packed into a payload of the RTP packet. If an RTP header has been generated, the TS packet is packed into a tail of the generated RTP packet (Step 1608).

Whether the number of TS packets packed into the payload of the RTP packet has reached a maximum for transmission without exceeding MTU of the line 76 is judged (Step 1609). If a result shows that the number of packed TS packets has reached the maximum, an IP header and a UDP header are added to the generated RTP packet to output the RTP packet to the line (Step 1610). Then, the process returns to the TS packet acquisition processing (Step 1601).

On the other hand, if the number of packed TS packets does not exceed the maximum, to pack more TS packets into the RTP packet, the process proceeds to the TS packet acquisition processing of Step 1601.

The MTU where the line 76 is Ethernet is 1500 bytes. Thus, the maximum number of TS packets permitted to be packed into one RTP payload is seven. The judgment of Step 1609 is carried out to prevent fragmentation of the RTP packet during the processing. As long as the number of TS packets takes a value which causes no fragmentation of the RTP packet, the maximum number of TS packets not exceeding the MTU of the line may not be packed. When a video is obtained in real time, an encoding delay may disable periodic acquisition of TS packets. In this case, transmission does not have to be delayed until the maximum number of TS packets can be packed.

FIG. 41 illustrates a configuration example of an IP packet generated and output to the line by the processing of Steps 1601 to 1610 of the ninth embodiment of this invention.

As illustrated in FIG. 41, a plurality of TS packets have been packed into a payload of the RTP packet. The TS packet containing a GOP start code is packed into a head of the RTP payload. If the TS packet containing the GOP start code is contained in the RTP packet, “1” is set in the P bit (78) of the RTP header. If only the TS packet not containing any GOP start code is contained in the RTP packet, “0” is set in the P bit (78) of the RTP header.

<Metadata Sever>

Next, the metadata server 65 will be described.

The metadata server 65 has a hardware configuration similar to that of the video gateway 61 illustrated in FIG. 34. In other words, the metadata server 65 includes the CPU 71, the memory 72, the bus 73, and the interface 74. The interface 74 is connected to the line 76 connected to the network A 67. The metadata server 65 does not include the interface 75.

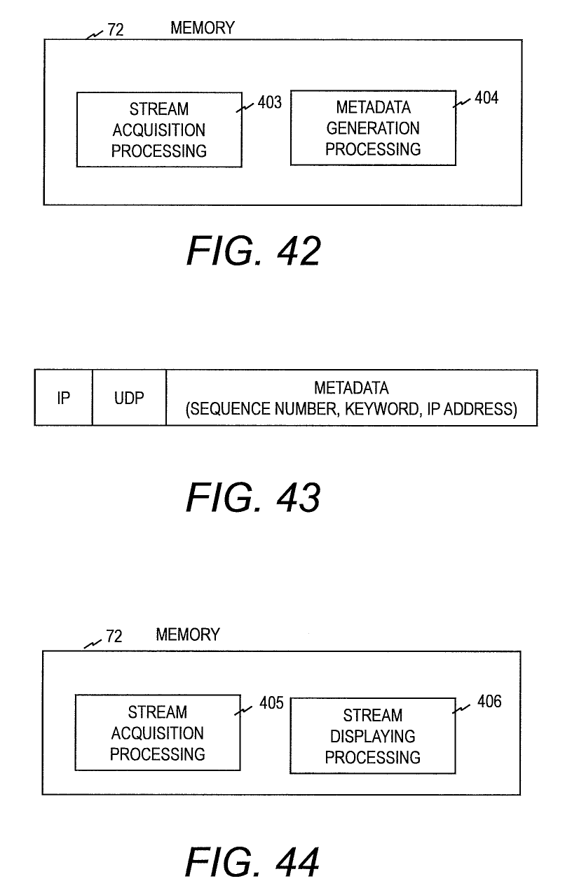

FIG. 42 illustrates a configuration of the memory 72 of the metadata server 65 according to the ninth embodiment of this invention.

The memory 72 of the metadata server 65 stores the stream acquisition program 403 and a metadata generation program 404.

The stream acquisition program 403 obtains stream packets sent from the video servers A to C (62 to 64). The stream packets may be obtained through the network A 67. A dedicated line directly connected to the video servers A to C (62 to 64) may be used. The video servers A to C (62 to 64) and the metadata server 65 may be mounted on the same hardware, and the stream packets may be obtained via the memory 72.

The metadata generation program 404 generates metadata corresponding to the video streams obtained by the stream acquisition program 403. The metadata associates a keyword indicating a video content, an RTP sequence number, and ID of the video server with one another. The keyword contained in the metadata is decided based on information from a sensor attached to a camera or a result of analyzing an image contained in the video stream.

FIG. 43 illustrates a configuration example of a metadata notification according to the ninth embodiment of this invention.

The metadata contains at least a keyword indicating a video content, a sequence number of an RTP header of a video associated with the keyword, and ID for specifying a video server. The keyword and the video are associated with each other as GOP units. An RTP packet containing a video corresponding to the notified metadata always contains a head of the GOP. According to this embodiment, as ID of each of the video servers A to C (62 to 64), a destination address of a multicast group to which the video server distributes the video stream is used.

<Video Client>

Next, the video client 66 will be described.

The video client 66 has a hardware configuration similar to that of the video gateway 61 illustrated in FIG. 34. In other words, the video client 66 includes the CPU 71, the memory 72, the bus 73, and the interface 75. The interface 75 is connected to the line 77 connected to the network B 68. The video client 66 does not include the interface 74.

FIG. 44 illustrates a configuration of the memory 72 of the video client 66 according to the ninth embodiment of this invention.

The memory 72 of the video client 66 stores a stream acquisition program 405, and a stream display program 406.

The stream acquisition program 405 obtains a video stream packet via the interface 75 and the line 77. The stream display program 406 displays the video stream obtained by the stream acquisition program 405 on a display screen (or outputs the video stream in a signal of an output permitted format to the display screen).

### Processing of Ninth Embodiment

Processing of each embodiment of this invention is carried out by the CPU 71 of each device executing the program stored in the memory 72. Some or all parts of the processing may be executed not by executing the program but by a hardware logic.

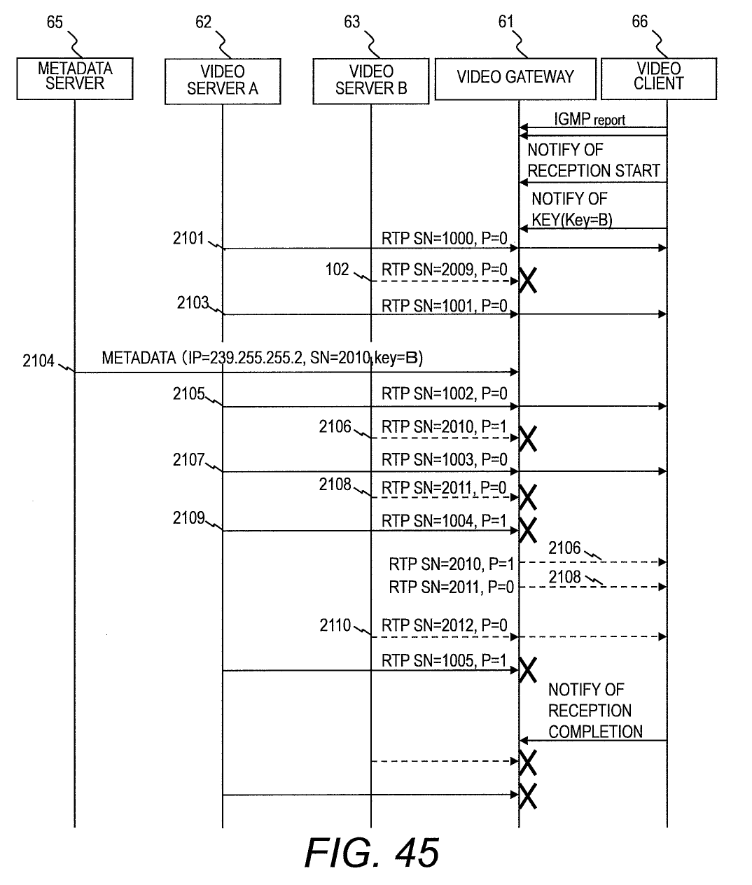

FIG. 45 is a sequence diagram illustrating video stream switching processing according to the ninth embodiment of this invention.

The video client 66 transmits a report of IGMP to the network B 68 to obtain video streams distributed from the video servers A to C (62 to 64). The video gateway 61 receives the report of IGMP transmitted by the video client 66. The received report of IGMP is transferred to the multicast router (not shown) of the network A 67 by the multicast control program 124. Through this processing, the video client 66 participates in the multicast group to which the video servers A to C (62 to 64) distribute videos.

The video client 66 transmits a reception start notification for notifying of permission of receiving a personalized stream to the video gateway 61. The reception start notification contains a port number for waiting for reception of the personalized stream.

The video gateway 61 executes, after reception of the reception start notification from the video client 66, personalized stream control processing.

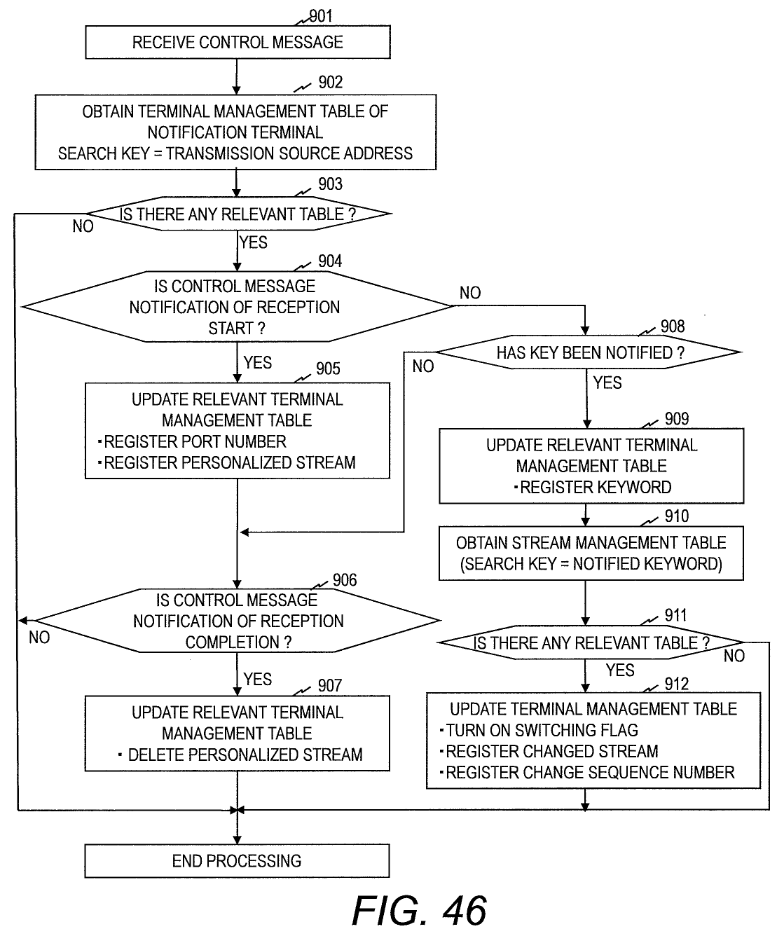

FIG. 46 is a flowchart illustrating personalized stream control processing carried out by the personalized stream control program 121 according to the ninth embodiment of this invention.

First, the video gateway 61 receives a control message (Step 901), and extracts a transmission source IP address (IP address of the video client 66) from the received control message to search for a terminal management table 126 by using the extracted transmission source IP address (Step 902).

If there is no terminal management table 126 of the video client 66 (“NO” in Step 903), the processing is finished. If there is a terminal management table 126 of the video client 66 (“YES” in Step 903), a type of the control message is specified (Step 904).

If the control message is a reception start notification (“YES” in Step 904), the notified waiting port number is registered in the port number 82 of the terminal management table 126 of the video client 66 to start distribution of personalized streams (Step 905).

If there is no keyword 83 registered in the terminal management table 126 of the video client 66, an optional stream is selected from the stream management table 127, and a multicast address of the selected stream is registered in the personalized stream 84. According to this embodiment, 239.255.255.1 (destination address of the multicast group to which the video server A 62 distributes the video stream) is registered.

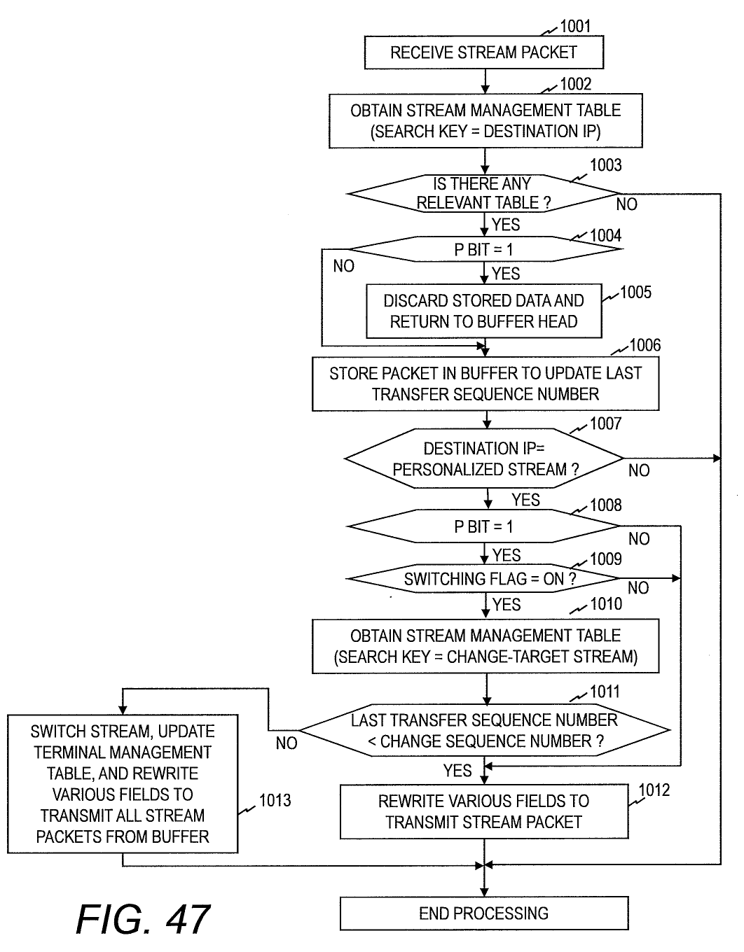

In the personalized stream 84 of the terminal management table 126, an IP address of an optional stream is registered only at first processing. Thereafter, an IP address is registered at the stream switching execution of personalized stream distribution processing described below (Step 1013 of FIG. 47).

Referring back to FIG. 45, the video client 66 transmits a key notification containing a keyword of a user-desired video of the client to the video gateway 61. The video gateway 61 that has received the key notification executes personalized stream control processing (FIG. 46). The video gateway 61 that has received the key notification executes Steps 901 to 903, and proceeds to Step 909 because judgment is “NO” in Step 904 and “YES” in Step 908.

Then, the keyword is extracted from the key notification sent from the video client 66, and the extracted keyword is registered in the keyword 83 of the terminal management table 126 (Step 909).

A stream management table 127 is searched by using the notified keyword (Step 910). If the keyword notified from the video client 66 matches the keyword 92 registered in the stream management table 127, the switching flag 85 of the terminal management table 126 is set to “ON”. The IP address 91 of the stream management table 127 is registered in the change-target stream 86 of the terminal management table 126. The change sequence number 93 of the stream management table 127 is registered in the change sequence number 87 of the terminal management table 126. Then, the processing is finished.

On the other hand, if the keyword notified from the video client 66 does not match the keyword 92 registered in the stream management table 127, the processing is finished without updating the terminal management table 126.

Referring back to FIG. 45 again, after reception of the stream packet sent from the video server A 62, the video gateway 61 executes personalized stream distribution processing.

FIG. 47 is a flowchart illustrating personalized stream distribution processing executed by the personalized stream distribution program 122 according to the ninth embodiment of this invention.

First, the video gateway 61 extracts, after reception of a stream packet (Step 1001), a destination address from the received stream packet, and searches for a stream management table 127 by using the extracted destination address (Step 1002).

If the destination address of the received stream packet has not been registered in the stream management table 127 (“NO” in Step 1003), the processing is finished. On the other hand, if the destination address of the received stream packet has been registered in the stream management table 127 (“YES” in Step 1003), presence/absence of a P bit of an RTP header of the received stream packet is judged (Step 1004).

If “1” is set in the P bit, buffered data among the data of the received stream is discarded (Step 1005), and the received stream packet is stored in a head of a buffer (buffer ID=“1”) (Step 1006). On the other hand, if “1” is not set in the P bit, the received stream packet is stored in a buffer next to a buffer where a last stream packet has been stored (Step 1006).

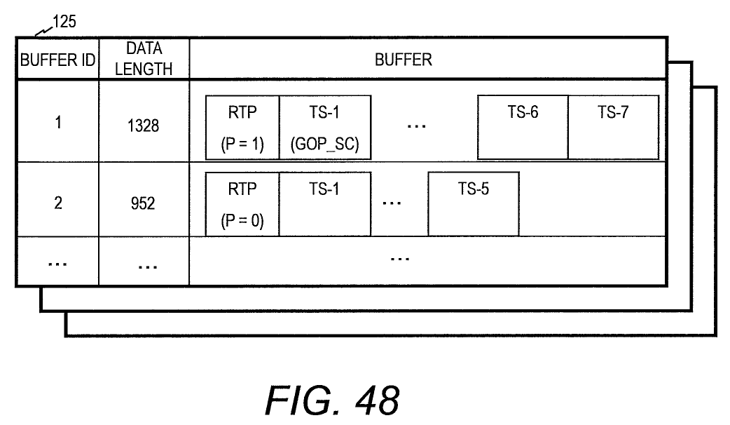

FIG. 48 illustrates a configuration of the buffer 125 which stores an RTP packet according to the ninth embodiment of this invention. The buffer 125 has a capacity greater than 1 GOP, buffer ID different from one RTP packet to another is added, and the buffer is stored. A buffer different from one stream (IP address 81) to another registered in the stream management table is held to be managed for each stream.

Then, by using a destination IP address of the stream packet, all personalized streams 84 of the terminal management table 126 are searched (Step 1007). If the destination IP address of the stream packet does not match the personalized stream 84 of the terminal management table 126 (“NO” in Step 1007), the processing is finished. On the other hand, if the destination IP address of the stream packet matches the personalized stream 84 of the terminal management table 126 (“YES” in Step 1007), whether a P bit of the stream packet has been set is judged (Step 1008).

If “1” is not set in the P bit of the stream packet (“NO” in Step 1008), the process proceeds to Step 1012 to rewrite the destination address of the IP header and the destination port number of the DPU header of the received stream packet with information obtained from the terminal management table 126. The sequence number of the RTP, the PID, the continuity counter, or PTS or DTS of the TS packet, or PCR or PAT of the PES header may be rewritten. The stream packet whose header has been rewritten is transmitted as a personalized stream to the video client 66 (Step 1012).

On the other hand, if “1” is set in the P bit (“YES” in Step 1008), whether the switching flag 85 of the terminal management table 126 has been set is judged (Step 1009).

If “ON” is not set in the switching flag 85 (“NO” in Step 1009), the IP header of the received stream packet is rewritten, and the stream packet whose header has been rewritten is transmitted (Step 1012) to finish the processing.

On the other hand, if “ON” is set in the switching flag 85 (“YES” in Step 1009), an entry of an IP address registered in the change-target stream 86 of the terminal management table 126 is obtained from the stream management table 127 (Step 1010). Then, the last transfer sequence number 94 of the stream management table 127 corresponding to the IP address of the change-target stream is compared with the change sequence number 93 of the terminal management table 126 (Step 1011).

If a result shows that the last transfer sequence number 94 is smaller than the change sequence number 93 (“YES” in Step 1011), a stream packet at a changing point has not reached the video gateway 61. Thus, no stream switching is carried out. Then, the IP header of the received stream packet is rewritten, and the stream packet whose header has been rewritten is transmitted (Step 1012) to finish the processing.

On the other hand, if the last transfer sequence number 94 is equal to the change sequence number 93 or larger (“NO” in Step 1011), judging that a stream switching timing has been reached, the stream is switched. Specifically, for the stream packet stored in the buffer 125 of the change-target stream, as in the case of Step 1012, the IP header or the like is rewritten, and the stream packet whose header has been rewritten is transmitted. The IP address registered in the change-target stream 86 of the terminal management table 126 is registered in the personalized stream 84. Then, the switching flag 85 is updated to OFF to clear pieces of information registered in the change-target stream 86 and the change sequence number 87 (Step 1013). Then, the processing is finished.

Referring back to FIG. 45, stream packets 2101 and 2103 sent from the video server A 62 are selected as personalized streams. Because no P bit has been set, processing of Steps 1001 to 1004, Steps 1006 to 1008, and Step 1012 of the personalized stream distribution processing (FIG. 47) is carried out. Thus, the video gateway 61 stores the stream packets 2101 and 2103 in the buffer 125 to transfer them as personalized streams to the video client 66.

For the stream packet 2102 sent from the video server B 63, no bit is set, and the stream packet 2102 has not been registered as a personalized stream in the terminal management table. Thus, processing of Steps 1001 to 1004 and Steps 1006 and 1007 of the personalized stream distribution processing (FIG. 47) is carried out. Accordingly, the video gateway 61 stores the stream packet 2102 in the buffer 125 to finish the processing.

After reception of the metadata 104, the video gateway 61 executes the metadata analysis program 123 to carry out metadata analysis processing.

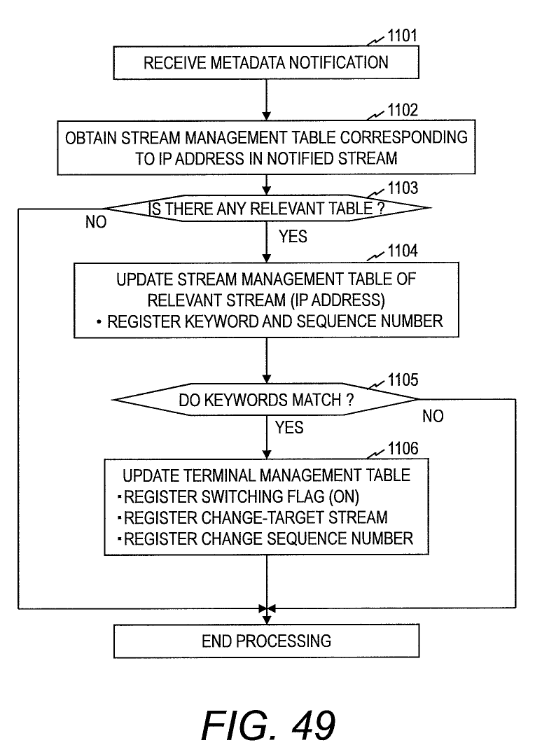

FIG. 49 is a flowchart illustrating the metadata analysis processing carried out by the metadata analysis program 123 according to the ninth embodiment of this invention.

First, the video gateway 61 extracts, after reception of metadata (Step 1101), an IP address from the received metadata, and retrieves the stream management table 127 by using the extracted IP address (Step 1102).

If the IP address contained in the received metadata has not been registered in the stream management table 127 (“YES” in Step 1103), the processing is finished. On the other hand, if the IP address contained in the received metadata has been registered in the stream management table 127 (“NO” in Step 1103), a keyword and a sequence number contained in the received metadata are respectively registered in the keyword 92 and the change sequence number 510 of the stream management table 127 (Step 1104).

Then, the keyword notified through the metadata is compared with all the keywords 83 of the terminal management table 126 (Step 1105). If the keyword notified through the metadata does not match any one of the keywords 83 of the terminal management table 126, this means that there is no video stream to be switched. Thus, the processing is finished.

On the other hand, if the keyword notified through the metadata matches any one of the keywords 503 of the terminal management table 126, the terminal management table 126 is updated (Step 1105). Specifically, the switching flag 85 of the terminal management table 126 is set to “ON”, and the IP address and the sequence number notified through the metadata are registered in the change-target stream 86 and the change sequence number 87 of the terminal management table 126.

Through the processing described above, based on the received metadata 104, the terminal management table 126 and the stream management table 127 are updated.

Referring back to FIG. 45, in this case, the keyword sent from the video client 66 matches the keyword contained in the metadata 104. Thus, the switching flag 85 of the terminal management table is set to ON. However, for the stream packets 2105 and 2107 subsequently sent from the video server A 62, no P bit has been set. Thus, the video gateway 61 processes the stream packets 2105 and 2107 as in the case of the stream packet 2101.

The sequence number of the stream packet 2106 sent from the video server B 63 is a stream switching point since it is similar to the sequence number notified through the metadata notification 2104 and a P bit has been set. However, when the stream packet 2106 arrives, the stream A has not reached the switching point. Thus, the stream cannot be switched. Accordingly, Steps 1001 to 1007 and Step 1012 of the personalized stream distribution processing (FIG. 47) are carried out to store the stream packet 2106 in the buffer 125. A stream packet 2108 arriving after the stream packet 2106 is similarly stored in the buffer 125.

For a stream packet 2109 sent from the video server A 62, a P bit has been set. Since the switching flag of the terminal management table 126 is “ON”, the stream is switched. In other words, Steps 1001 to 1011 and 1013 of the personalized stream distribution processing (FIG. 47) are carried out. The stream packet 2109 is not transferred but stored in the buffer. The stream packets 2106 and 2108 sent from the video server B 63 are read from the buffer, and the destination address of the IP header and the destination port number of the UDP header are rewritten with pieces of information obtained from the terminal management table 126. The sequence number of the RTP, the PID of the TS packet, the continuity counter, or the PTS or DTS of the PES header such as a PCR or a PAT may be rewritten. The stream packet whose header has been rewritten is transmitted as a personalized stream to the video client 66.

A stream packet 2110 sent from the video server B 63 and arriving after the stream switching is stored in the buffer through processing of Steps 1001 to 1004 and 1006 to 1008 and 1012, and transmitted as a personalized stream to the video client 66.

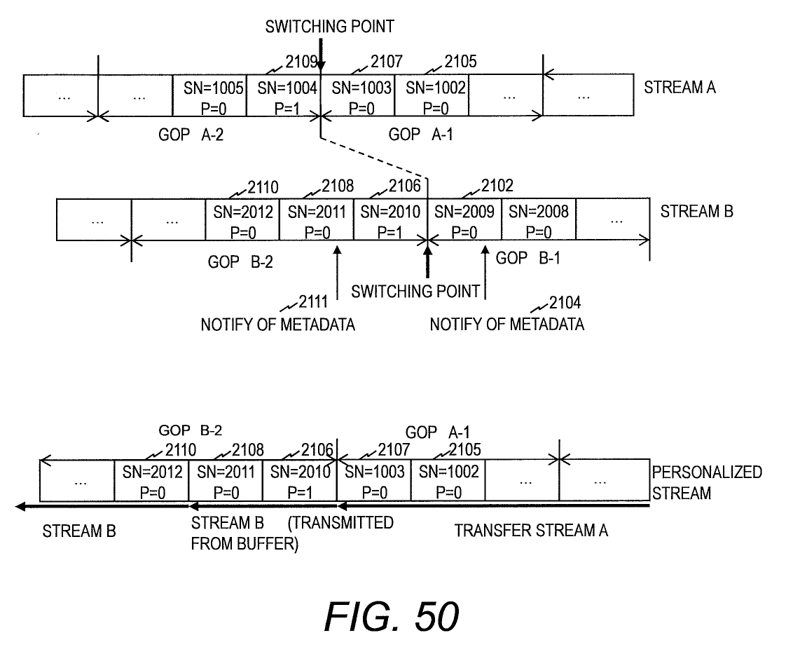

FIG. 50 illustrates a personalized stream where a stream distributed from the video server has been switched according to the ninth embodiment of this invention. Specifically, FIG. 50 illustrates a personalized stream which the video gateway 61 has transmitted through switching the stream A distributed from the video server A 62 to the stream B distributed from the video server B 63 as illustrated in the sequence of FIG. 45. In FIG. 50, time flows from right to left.

When a video stream is switched corresponding to a keyword notified through the metadata 2104, the stream A (end stream) whose transfer is halted by switching is transferred to the stream packet 2107 which is a GOP tail, and then the stream is switched.

For a stream (start stream) started to be transferred by switching, transfer is started from the stream packet 2106 which becomes a start of GOP stored in the buffer 125. After transfer completion of the stream packet stored in the buffer 125, as in the case of the stream packet 2110, a stream packet is transferred as soon as it arrives. Thus, the video client 66 can receive the end stream until the GOP tail, and the start stream from a GOP start.

According to the video relaying method of the ninth embodiment, even when a metadata notification arrives after the switching point (111), through similar processing, the stream B can be transmitted from a GOP head. When metadata arrives late by more than 1 GOP which is an update unit of the buffer 125, the stream can be switched from a head of the nearest GOP. By installing a buffer 125 having a capacity greater than 1 GOP, even when the metadata arrives late by more than 1 GOP, a new stream can be transmitted from a GOP head.

The ninth embodiment uses the MPEG 2 for a video encoding method. However, the embodiment can be applied to all those using other video encoding methods, as long as they are video distribution systems for dividing one frame into a plurality of packets to transmit it.

As described above, according to the ninth embodiment, corresponding to metadata which is additional information of a video, in view of a playing unit of a video stream, the video can be switched to be playable without boundaries. The video data of a start stream is stored in the buffer 125. Thus, even when the metadata is notified later than the stream data of the switching point, without interfering with playing, the video client can switch a video stream continuously from a video playable point. Moreover, since the video is switched by referring to the header of the stream data, processing of identifying a switching point can be reduced.

### Tenth Embodiment

Next, a tenth embodiment of this invention will be described.

According to the tenth embodiment, video servers A to C (62 to 64) provide marks for notifying not only a GOP head but also a GOP tail, a point immediately before an I or P frame, and a start of the I or P frame. Thus, streams can be switched more quickly than the ninth embodiment.

A video distribution system and devices of the tenth embodiment are similar in configuration to those of the ninth embodiment.

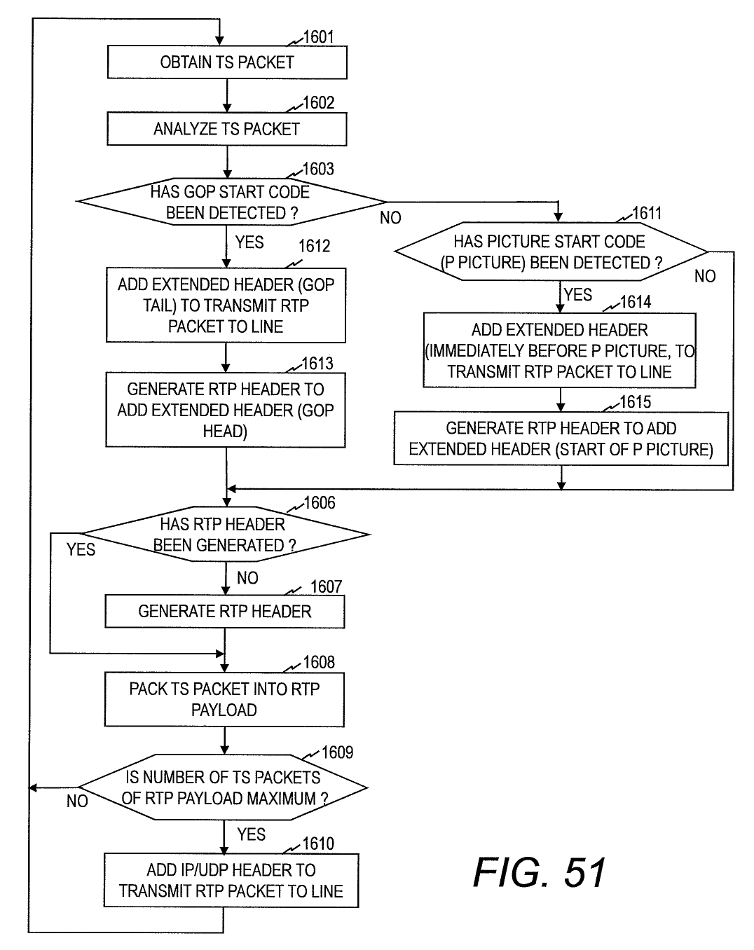

FIG. 51 is a flowchart illustrating stream packet generation processing executed by a stream packet generation program 402 according to the tenth embodiment of this invention. Steps similar to those of the stream packet generation processing (FIG. 39) of the ninth embodiment are denoted by similar reference numerals, and description thereof will be omitted.

Whether a TS packet obtained in Step 1603 contains a GOP start code or a picture start code is analyzed.

If the TS packet contains a GOP start code (“YES” in Step 1603), an extended header indicating a GOP tail is added to an RTP packet which has been generated, and the generated RTP packet is output to a line 76 (Step 1612). A new RTP header is generated to set an extended header indicating a GOP head (Step 1613).

If it is judged in Step 1603 that the TS packet contains no GOP start code (“NO” in Step 1603), whether the obtained TS packet contains a picture start code is judged. If the picture start code is contained, a picture type is checked to judge whether it is a P picture. If the TS packet contains a picture start code (“YES” in Step 1611), an extended header indicating a status immediately before a P picture is added to an RTP packet which has been generated, and the generated RTP packet is output to the line 76 (Step 1614). Then, a new RTP header is generated to set an extended header indicating a start of the P picture (Step 1615).

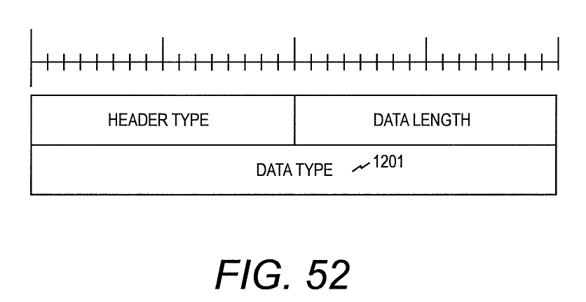

FIG. 52 illustrates a configuration of an extended header of an RTP according to the tenth embodiment of this invention.

The extended header of the RTP contains a type of an extended header, a data length, and a type of data packed in an RTP payload. The data type includes any one of a GOP head, a GOP tail, a point immediately before a P picture (frame), and a start of a P picture (frame).

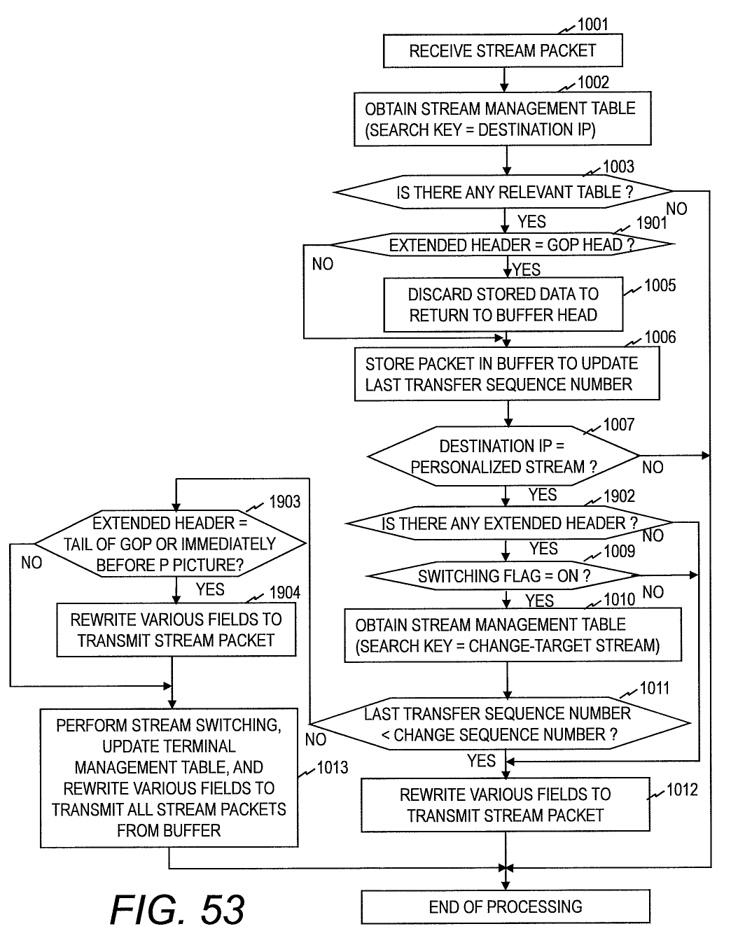

FIG. 53 is a flowchart illustrating personalized stream distribution processing executed by a personalized stream distribution program 122 according to the tenth embodiment of this invention. Steps similar to those of the personalized stream distribution processing (FIG. 47) of the ninth embodiment are denoted by similar reference numerals, and description thereof will be omitted.

In the personalized stream distribution processing of the tenth embodiment, a switching timing of a video stream is judged by using an extended header of an RTP.

Specifically, in the personalized stream distribution processing of the tenth embodiment, Steps 1001 to 1003 are carried out. Then, if a destination address of a received stream packet has been registered in the stream management table 127 (“NO” in Step 1003), whether a data type of an extended header of an RTP of the received stream packet indicates a “GOP head” is judged (Step 1901). If the data type of the extended header of the RTP indicates a “GOP head”, data that has been buffered among data of the received stream is discarded (Step 1005), and the received stream packet is stored in a head area (buffer ID=“1”) of the buffer 125 (Step 1006). On the other hand, if no “GOP head” is set in the data type of the extended header of the RTP, the received stream packet is stored in an area (buffer ID=“2”) next to a buffer where a last stream packet has been stored (Step 1006).

After execution of Step 1007, if the destination IP address of the stream packet matches the personalized stream 84 of the terminal management table 126 (“YES” in Step 1007), whether an extended header has been added to the RTP packet is judged (Step 1902). If a result shows that an extended header has been added to the RTP packet, Step 1009 is executed. On the other hand, if no extended header has been added to the RTP packet, the process proceeds to Step 1012.

If it is judged in Step 1011 that the last transfer sequence number 94 is equal to the change sequence number 93 or larger (“NO” in Step 1011), whether a data type of the extended header of the RTP indicates a “GOP tail” or “immediately before P frame” is judged (Step 1903). If the data type of the extended header of the RTP indicates a “GOP tail” or “immediately before P frame”, a destination address of the IP header and a destination port number of the UPP header of the stream packet received in Step 1001 are rewritten with pieces of information obtained from the terminal management table 126. A sequence number of the RTP, a PID of the TS packet, a continuity counter, or PTS or DTS of PES such as PCR or PAT may be rewritten. Then, the stream packet whose header has been rewritten is transmitted as a personalized stream to the video client 66 (Step 1904). Then, the process proceeds to Step 1013.

Other steps are similar to those of the personalized stream distribution processing (FIG. 47) of the ninth embodiment.

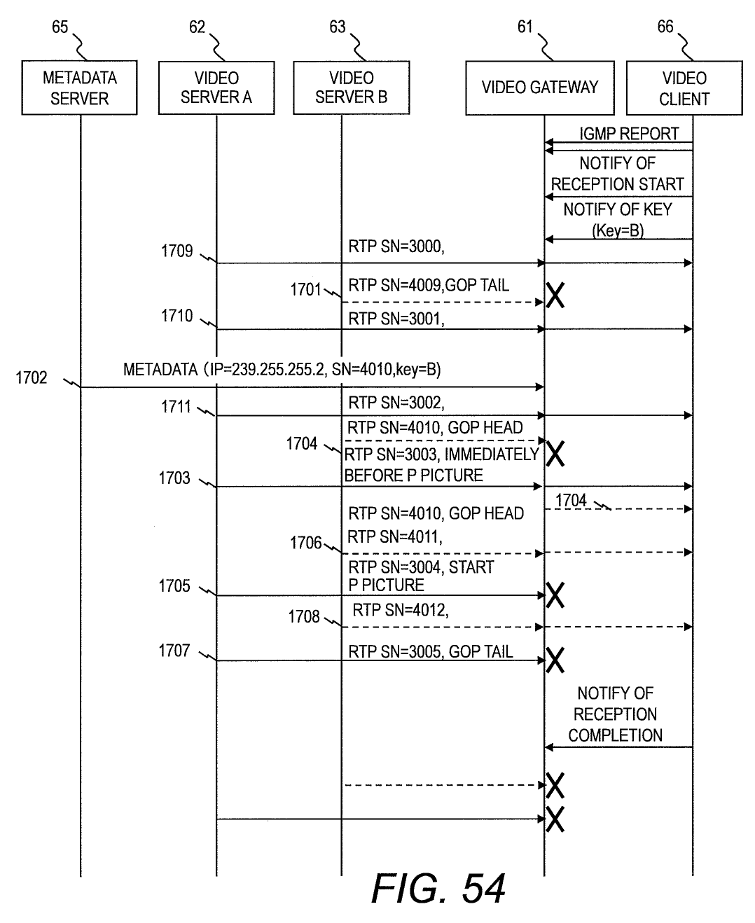

FIG. 54 is a sequence diagram illustrating video stream switching processing according to the tenth embodiment of this invention.

The video client 66 transmits a report of IGMP to the network B 68 to obtain original video streams distributed from the video servers A to C (62 to 64). The video gateway 61 receives the report of IGMP transmitted by the video client 66. The received report of IGMP is transferred to a multicast router (not shown) of the network A 67 by multicast control processing 124. Through this processing, the video client 66 participates in a multicast group to which the video servers A to C (62 to 64) distribute videos.

The video client 66 transmits a reception start notification for notifying reception permission of a personalized stream to the video gateway 61. The reception start notification contains a number of a port which is waiting for reception of a personalized stream.

After reception of the reception start notification from the video client 66, the video gateway 61 executes personalized stream control processing (FIG. 46). An arbitrary stream is selected and registered as a personalized stream for the beginning, and in this embodiment, it is presumed that a stream (destination address 239.255.255.1) distributed from the video server A 62 is registered as a personalized stream. Then, the video client 66 transmits a key notification containing a keyword of a video desired by a user of the client to the video gateway 61. The video gateway 61 executes, after reception of the key notification, personalized stream control processing (FIG. 46).

Then, after reception of a stream packet transmitted from the video server A 62, the video gateway 61 executes personalized stream distribution processing (FIG. 53).

Stream packets 1709 and 1710 sent from the video server A 62 are selected as personalized streams. Because no (RTP extended header has been set, processing of Steps 1001 to 901, Steps 1006 to 902, and Step 1012 of the personalized stream distribution processing (FIG. 53) is carried out. Thus, the video gateway 61 stores the stream packets 1709 and 1710 in the buffer 125 to transfer them as personalized streams to the video client 66.

On the other hand, a stream packet 1701 transmitted from the video server B 63 has not been selected as a personalized stream. Since an extended header of a stream packet 2102 transmitted from the video server B 63 does not indicate a “GOP head”, Steps 1001 to 1901 and Steps 1006 and 1007 of the personalized stream distribution processing (FIG. 53) are executed. Accordingly, the video gateway 61 stores the stream packet 1701 in the buffer 125.

After reception of the metadata 1702, the video gateway 61 executes the metadata analysis program 123 to carry out metadata analysis processing (FIG. 49).

Since a keyword transmitted from the video client 66 matches a keyword contained in the metadata 1702, a switching flag 85 of the terminal management table is set to ON. However, a stream packet 1711 subsequently transmitted from the video server A 62 has no RTP extended header. Thus, the video gateway 61 processes the stream packet 1711 as in the case of the stream packet 1709.

The sequence number of the stream packet 1704 sent from the video server B 63 is a stream switching point since it is similar to the sequence number notified through the metadata notification 1702, and contains an extended header indicating a “GOP head”. However, since the stream A has not reached the switching point when the stream packet 1704 arrives, the stream cannot be switched. Thus, Steps 1001 to 1007 of the personalized stream distribution processing (FIG. 53) are executed to store the stream packet 2107 in the buffer 125.

The stream packet 1703 sent from the video server A 62 contains an extended header indicating “immediately before P picture”. The switching flag 505 of the terminal management table 126 is “ON”, and a packet of the stream switching point has arrived. Thus, after transfer of the stream packet, the stream is switched. In other words, Steps 1001 to 1901, 1005 to 1011, and 1903 to 1013 of the personalized stream distribution processing (FIG. 53) are executed. The stream packet 1703 is transferred as a personalized stream to the video client 66, and further stored in the buffer 125 as well. The stream packet 1704 sent from the video server B 63 is read from the buffer 125, and transmitted as a personalized stream to the video client 66.

Stream packets 1706 and 1708 sent from the video server B 63 and arriving at the video gateway 61 after the stream switching are stored in the buffer 125 through processing of Steps 1001 to 1901 and 1006 and 1007.

On the other hand, stream packets 1705 and 1707 which have been sent from the video server A 62 and reached the video gateway 61 after stream switching are stored in the buffer 125 through execution of Steps 1001 to 1901, and 1006 and 1007.

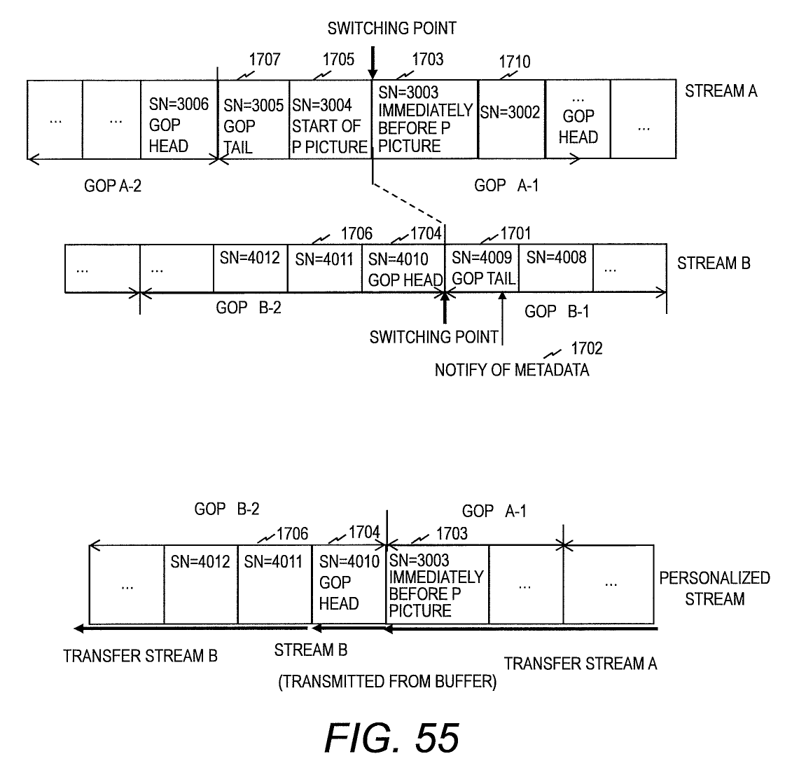

FIG. 55 illustrates a personalized stream where a stream distributed from the video server has been switched according to the tenth embodiment of this invention. Specifically, FIG. 55 illustrates a personalized stream which the video gateway 61 has transmitted through switching the stream A distributed from the video server A 62 to the stream B distributed from the video server B 63 as illustrated in the sequence of FIG. 54. In FIG. 55, time flows from right to left.

When a video stream is switched corresponding to a keyword notified through the metadata 1702, the stream A (end stream) whose transfer is halted by switching is transferred to the stream packet 1703 immediately before a P picture without waiting for a GOP tail, and then the stream is switched.

For a stream (start stream) started to be transferred by switching, transfer is started from the stream packet 1704 which becomes a start of GOP stored in the buffer 125. After transfer completion of the stream packet stored in the buffer 125, as in the case of the stream packet 1706, a stream packet is transferred as soon as it arrives. Thus, the video client 66 can receive the end stream until immediately before the P picture, and the start stream from a GOP start.

As described above, according to the tenth embodiment of this invention, transfer of a stream to be finished is halted immediately before a start of a P frame in addition to a GOP boundary. Thus, the video gateway 61 can detect an end point of the stream earlier than that according to the ninth embodiment, and switch a video stream more quickly.

### Eleventh Embodiment

Next, an eleventh embodiment of this invention will be described.

The eleventh embodiment is directed to a configuration where even in a video distribution system having functions of the video gateway 61 arranged in the video client 66 and no video gateway, video streams can be switched.

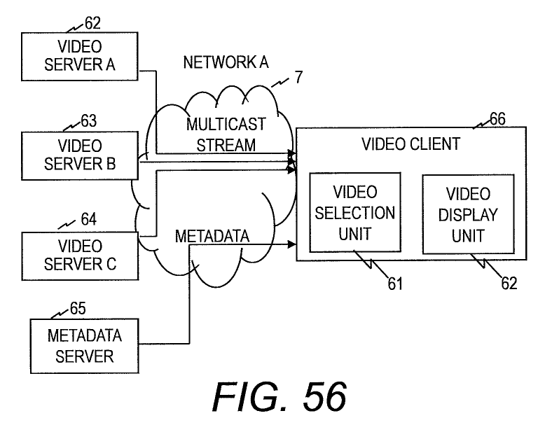

FIG. 56 illustrates a system configuration of a video distribution system according to the eleventh embodiment of this invention.

The video distribution system of the eleventh embodiment includes video servers A to C (62 to 64), a metadata server 65, and a network A 67. A video client 66 is connected to the network A 67.

The video client 66 of the eleventh embodiment of this invention includes a video selection unit 60 and a video display unit 69. The video display unit 69 includes a stream acquisition program 405 and a stream display program 406 (FIG. 44). The video selection unit 60 includes a personalized stream control program 121, a personalized stream distribution program 122, a metadata analysis program 123, a multicast control program 124, a buffer 125, a terminal management table 126, and a stream management table 127 (FIG. 35). Processing executed by each program is similar to that of the ninth embodiment.

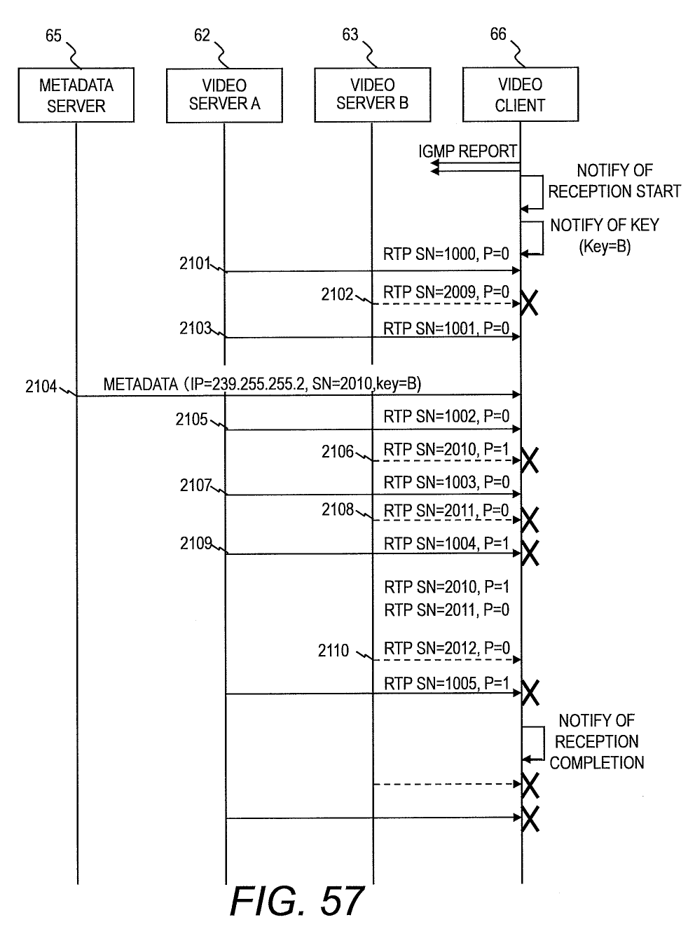

FIG. 57 is a sequence diagram illustrating video stream switching processing according to the eleventh embodiment of this invention.

According to the eleventh embodiment, the video client 66 directly transmits a multicast control request (report of IGMP) to a multicast router on an upstream side (not shown).

A reception start request, a key notification, and a reception end notification are notified to the personalized stream control program 121 via a memory 12 as internal processing of the video client 66. Personalized stream control processing when a control message is received is similar to that of the tenth embodiment. The terminal management table 126 manages only information of its own video client 66.

The stream acquisition program 405 receives all stream packets sent from the video servers A to C (62 to 64). The received stream packets are passed to the personalized stream distribution program 122 as internal processing of the video client 66.

After reception of the stream packets, as in the case of the tenth embodiment, the personalized stream distribution program 122 selects a stream packet in Steps 1012 and 1013 (FIG. 47). The selected stream packet is not output to any line but passed to the stream acquisition program 405 as internal processing of the video client 66 (e.g., via the memory). The stream acquisition program 405 obtains video data from the stream packet passed from the personalized stream distribution program 122, and sends the obtained stream packet to the stream display program 406. The stream display program 406 displays the stream packet on a display screen.

As described above, according to the eleventh embodiment, functions of the video gateway 61 are arranged in the video client 66. Thus, even in the video distribution system including no video gateway, video streams can be switched.

### Twelfth Embodiment

Next, a twelfth embodiment of this invention will be described.

The twelfth embodiment will be described by way of example where a video gateway 61 switches a stream for each metadata notification to distribute a digest stream.

A video distribution system and devices of the twelfth embodiment are similar in configuration to those of the ninth embodiment.

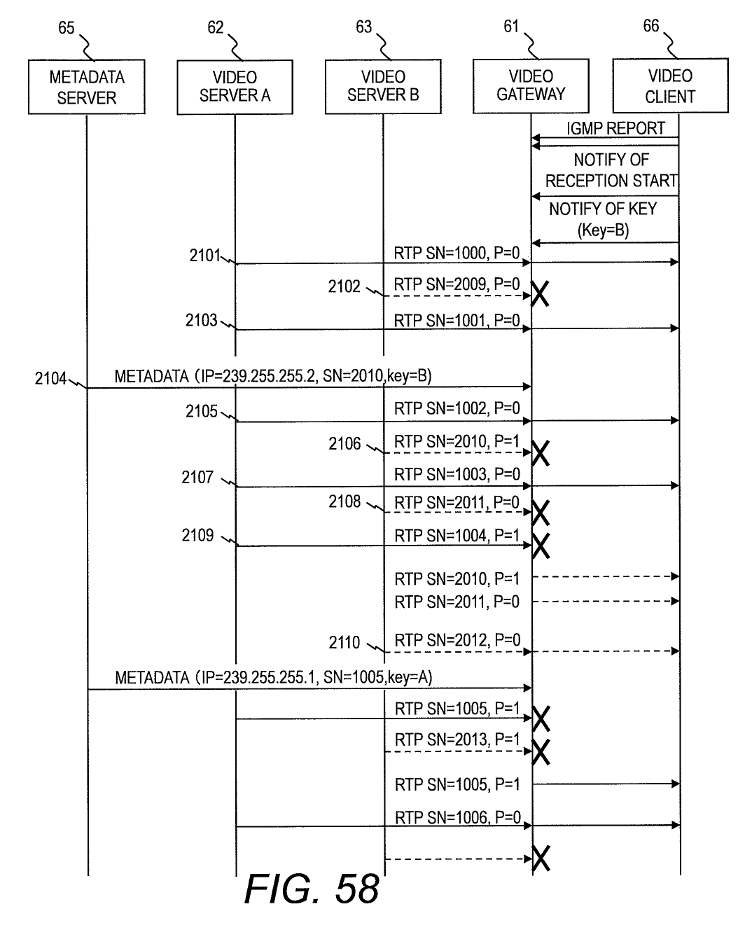

FIG. 58 is a sequence diagram illustrating video stream switching processing according to the twelfth embodiment of this invention.

In the twelfth embodiment, processing of the video gateway 61 when a control message is received from the video client 66, and processing of the video gateway 61 when a stream packet is received are similar to those of the ninth embodiment.

After reception of a metadata notification, the video gateway 61 executes a metadata analysis program 123 to carry out metadata analysis processing 123. According to the twelfth embodiment, keywords are not compared in Step 1105 of the metadata analysis processing (FIG. 49). For each reception of a metadata notification, a switching flag 85 of the terminal management table 126 is set to “ON” to register a change-target stream 86 and a change sequence number 87.

As a result, the video gateway 61 can switch a personalized stream for each notification of meta data.

Other steps are similar to those of the ninth embodiment.

As described above, according to the twelfth embodiment of this invention, by switching a personalized stream for each notification of metadata, the video gateway 61 can distribute digest streams of video streams distributed from the video servers A to C (62 to 64).

While the present invention has been described in detail and pictorially in the accompanying drawings, the present invention is not limited to such detail but covers various obvious modifications and equivalent arrangements, which fall within the purview of the appended claims.

What is claimed is:

1. A video distribution system, comprising:
a video server for transmitting a video stream; and
a video gateway for receiving a plurality of the transmitted video streams, and transferring at least one of the received plurality of the transmitted video streams to a video client,
wherein the video server is configured to:
add a first identifier for identifying whether data of an independently decodable unit included in the video stream corresponds in time to the video stream; and
transmit the video stream to which the first identifier has been added; and
wherein the video gateway is configured to:
specify, based on first identifiers added to the received plurality of video streams, the data of the independently decodable unit of the video stream transferred after the switching in a case where the video stream is switched to another video stream in the independently decodable unit; and
transfer the video stream transferred after the switching from the specified data of the independently decodable unit.

2. The video distribution system according to claim 1, wherein the video gateway is further configured to:
store at least a video stream of one independently decodable unit among the received plurality of video streams in a buffer;
receive meta-data indicating contents of the received plurality of video streams;
receive request information on the video stream from the video client; and
select a video stream to be distributed based on the received meta-data and the received request information.

3. The video distribution system according to claim 2, wherein the video gateway is further configured to:
delete data of the independently decodable unit which is an unselected video stream and to which the first identifier for identifying the same time as that of the transferred data of the independently decodable unit has been added from the buffer in the independently decodable unit, in a case where the selected video stream is transferred to the video client.

4. The video distribution system according to claim 2, wherein the video gateway is further configured to transfer an unselected video stream to the video client.

5. The video distribution system according to claim 1, wherein the independently decodable unit of the video stream is GOP data.

6. The video distribution system according to claim 1, wherein the video server is further configured to add the first identifier to a header of an RTP packet of a video stream broken into independently decodable units.

7. The video distribution system according to claim 1, wherein the video server is further configured to:
store the video stream;
read the stored video stream;
add the first identifier for identifying the data of the independently decodable unit included in the video stream corresponds in time to the read video stream; and
transmit the video stream to which the first identifier has been added.

8. The video distribution system according to claim 1, wherein the video gateway is further configured to:
generate a plurality of video streams to be distributed to the video client;
notify the video client of a second identifier for selecting one of the generated plurality of video streams; and
select a video stream specified by the second identifier selected by the video client.

9. The video distribution system according to claim 8, wherein the video client is configured to:
receive second identifiers for selecting a video stream from the video gateway;
select one of the received second identifiers;
transmit the selected second identifier to the video gateway;
receive a video stream selected by the video gateway; and
play the received video stream.

10. A video distribution system, comprising:
a video server for transmitting video streams; and
a video gateway for storing the video streams transmitted from the video server in a buffer, and transferring a selected one of video streams to a video client,
wherein the video server is configured to transmit the video stream by adding boundary information indicating a playable unit of the video stream, and
wherein the video gateway is configured to switch the video stream to be transferred only at a location of the boundary information.

11. The video distribution system according to claim 10, further comprising:
a meta-data server for transmitting information on the video streams transmitted from the video server,
wherein the meta-data server is configured to transmit meta-data including information on a subject included in the video streams and information on locations of the video streams corresponding to the information on the subject, and
wherein the video gateway is configured to:
receive the meta-data transmitted from the meta-data server and a video transmission request including the information on the subject included in the video streams and transmitted from the video client;
refer to the received meta-data to judge whether a video stream matching the received video transmission request has been distributed;
transfers, in a case where the video stream matching the received video transmission request has been distributed, a first video stream currently transferred up to a video specified by the boundary information and transfer a second video stream transferred after the switching from the video specified by the boundary information.

12. The video distribution system according to claim 11, wherein the video gateway is configured to:
store data of the second video stream in the buffer; and
delete the data of the second video stream stored in the buffer after reception of the boundary information on the second video stream.

13. The video distribution system according to claim 11, wherein the video stream includes at least a first frame which is independently playable without using any inter-frame prediction, and a second frame playable only based on a forward prediction from another frame, and
wherein the video gateway is configured to:
transfer the first video stream up to immediately before one of the first frame and the second frame; and
transfer the second video stream from the first frame.

14. The video distribution system according to claim 11, wherein the information on the locations of the video streams corresponding to the information on the subject includes an RTP sequence number of a video where the subject begins to appear.

15. The video distribution system according to claim 10, wherein the video server transmits the video stream using an RTP packet, and the boundary information is included in a header of the RTP packet.

16. The video distribution system according to claim 10, wherein the video server adds the boundary information to a location where a frame which can be independently played without using any inter-frame prediction is detected in the video stream to be distributed.

17. A video gateway for storing video streams transmitted from a video server in a buffer and transferring a selected one of video streams to a video client,
wherein the video server adds boundary information indicating a playable unit of the video stream to transmit the video stream,
wherein the video gateway is connected to a meta-data server for transmitting meta-data including information on a subject included in the video streams and information on locations of the video streams corresponding to the information on the subject, and
wherein the video gateway is configured to:
receive the meta-data transmitted from the meta-data server and a video transmission request including the information on the subject included in the video streams and transmitted from a video client;
refer to the received meta-data to judge whether a video stream matching the received video transmission request has been distributed; and
transfer, in a case where the video stream matching the received video transmission request has been distributed, a first video stream currently transferred up to a video specified by the boundary information and transfer a second video stream transferred after the switching from the video specified by the boundary information.

18. The video gateway according to claim 17, wherein the video gateway is configured to:
store data of the second video stream in the buffer; and
delete the data of the second video stream stored in the buffer after reception of the boundary information on the second video information.

19. The video gateway according to claim 17, wherein the video stream includes at least a first frame which is independently playable without using any inter-frame prediction, and a second frame playable only based on a forward prediction from another frame, and
wherein the video gateway is configured to:
transfer the first video stream up to immediately before one of the first frame and the second frame; and
transfer the second video stream from the first frame.

20. The video gateway according to claim 17, wherein the information on the locations of the video streams corresponding to the information on the subject includes an RTP sequence number of a video where the subject begins to appear.

21. The video gateway according to claim 17, wherein the video gateway is configured to:
receive the video stream transmitted using an RTP packet from the video server; and
extract the boundary information from a header of the RTP packet.

22. A video relaying method for a video distribution system, comprising:
a video server for transmitting video streams;
a video gateway for storing the video streams transmitted from the video server in a buffer, and transferring a selected one of video streams to a video client; and
a meta-data server for transmitting information regarding the video streams transmitted from the video server,
the method comprising the steps of:
adding, by the video server, boundary information indicating a playable unit of the video stream to transmit the video stream;
transmitting, by the meta-data server, meta-data including information on a subject included in the video streams and information on locations of the video streams corresponding to the information on the subject;
receiving, by the video gateway, the meta-data transmitted from the meta-data server and a video transmission request including the information on the subject included in the video streams and transmitted from the video client;
referring, by the video gateway, to the received meta-data to judge whether a video stream matching the received video transmission request has been distributed; and
transferring, by the video gateway, in a case where the video stream matching the received video transmission request has been distributed, a first video stream currently transferred up to a video specified by the boundary information and a second video stream transferred after the switching from the video specified by the boundary information.

23. The video relaying method according to claim 22, further comprising the steps of:
storing, by the video gateway, data of the second video stream in the buffer; and
deleting, by the video gateway, the data of the second video stream stored in the buffer after reception of the boundary information on the second video stream.

24. The video relaying method according to claim 22, wherein the video stream includes at least a first frame which is independently playable without using any inter-frame prediction, and a second frame playable only based on a forward prediction from another frame, the video relaying method further comprising the steps of:
transferring, by the video gateway, the first video stream up to immediately before one of the first frame and the second frame; and
transferring, by the video gateway, the second video stream from the first frame.

25. The video relaying method according to claim 22, wherein the information on the locations of the video streams corresponding to the information on the subject includes an RTP sequence number of a video where the subject begins to appear.

26. The video relaying method according to claim 22, further comprising the steps of:
transmitting, by the video server, the video stream using an RTP packet; and
extracting, by the video gateway, the boundary information from a header of the RTP packet.
